(19) United States
(12) Patent Application Publication
(10) Pub. No.: US 2011/0295669 A1
(43) Pub. Date: Dec. 1, 2011

(54) Internet-Assisted Systems and Methods for Building a Customer Base for Musicians

(76) Inventor: Jonathan Stiebel, Cambridge, MA (US)

(21) Appl. No.: 13/180,781

(22) Filed: Jul. 12, 2011

Related U.S. Application Data
(63) Continuation of application No. 12/455,097, filed on May 28, 2009.
(60) Provisional application No. 61/495,890, filed on Jun. 10, 2011.
(60) Provisional application No. 61/130,496, filed on May 30, 2008.

(51) Int. Cl. G06Q 30/00; G06Q 50/00

(52) U.S. Cl. 705/14.19; 705/347; 705/14.49

(57) ABSTRACT

Method for building a customer base for a musician, comprising offering a discount on food or drinks at a venue where a musician plays or has played a piece of music to a listener who hears or has heard the piece of music of the musician, the discount is to be in exchange for the listener providing a rating of the piece of music of the musician or the listener providing a rating of the musician, accepting a rating by the listener of the piece of music of the musician or a rating by the listener of the musician. Optionally, offering at least one song of the musician for purchase to the listener who rated the piece of music or offering a song of the musician for purchase to the listener who rated the musician. Optionally, wherein the at least one song of the musician comprises the piece of music.

### REFERENCE TO RELATED APPLICATIONS

The applications claims the benefit of the filing date of co-pending, of same inventor, U.S. Provisional Patent Application filed on Jun. 10, 2011, entitled, “System and Method for Publicizing Creative Works and Artists”—61/495,890. This application is a continuation in part of U.S. patent application Ser. No. 12/455,097, entitled “Next Song Proposing Engine,” filed May 28, 2009, the contents of which are incorporated herein by reference in their entirety, which claims benefit of U.S. Provisional Application No. 61/130,496 filed 30 May 08, entitled “Next-song proposing engine.” Which claims priority from U.S. Regular patent application Ser. No. 11/731,083, entitled “System and method for electronic media content delivery,” which was filed on 30 Mar. 07, claiming priority of U.S. provisional application Ser. No. 60/787,962 filed Mar. 31, 2006 and titled, “System and Method for Operation on Music Preference” by the present inventor, and U.S. provisional application Ser. No. 60/799,093 filed May 10, 2006 and titled, “System and Method for Operation on Music Preference.” Under 35-USC-119e all of which applications are hereby incorporated herein in their entirety.

### BACKGROUND OF THE INVENTION

1. Field of the Invention

This invention pertains to digital data processing and, more particularly, systems and method for software as a service over the internet connecting musicians with their fans with broader implications in internet marketing of digital content.

2. Background

From ancient to modern times, musicians performed live in front of their audience. At times the audience would purchase tickets to the performance, other times the audience would pay as it desired after the performance, alternatively, wealthy individuals would provide a stipend for specific talented musicians to compose and perform their music.

With the advent of the record player, and later radio, the industrial economy became well suited to dominate the music business. The performer needed to record their performance. The business could pay a premium to the performer because a slightly better performance should fair better in the marketplace, and the cost of distribution and marketing is no more for a better performance. Arguably, the cost of distribution can be less for a better performance due to increased market acceptance. Yet, reality was that a so-so performance with excellent marketing and distribution could dominate the radio airwaves and the record store shelves over an excellent performance without sufficient support.

This enabled the growth of music-based radio and record labels, two parallel business models worth tens of billions of annual revenues at their zenith. The synergy of 1950s radio with the music business was powerful. Radio would play music and test an audience reaction. Music that received a positive reaction would be played often. Such music began to dominate the music popularity charts and drive recorded music sales. Over time, technology progressed from records, to cassettes, and to compact disks. Each substantial improvement in technology was an opportunity for the record labels to sell their catalog again to the same consumers.

In the mid-1990s, radio started to consolidate. They realized that music discovery was a human and expert intensive process and that most music that was popular was good enough. So, they began to centralize and automate the playlists. Thus, they ensured their short-term profit margins grew, while destroying both the vitality of the listener experience and the core ecosystem that made both radio stations and music labels able to innovate and bring new music to the public.

In the 1990s, a new format arose that would in many ways replace the compact disk. However, this time, while record labels were extremely intrigued by the new format and spent hundreds of millions of dollars trying to figure it out, they failed initially to find a business model that made sense both to the record labels and to their consumers. In this vacuum arose Napster who, with $85 m in record label backing, provided mp3 music direct to consumer but failed to monetize. Rather than partner to find a way to monetize this venture that would cannibalize their recorded music sales, the group of major record labels sued in court to cause Napster to shut down.

In the 2000s, a variety of music sharing websites arose. Given the strongly antagonistic stance of the major record labels, these services had to focus on evading lawsuits rather than on how to create enduring and sharable monetization.

After a few years, Apple convinced the record labels to sell a single song of music for $1. Thus was born iTunes. Apple is said to have broken even on the music sales, paying 70% to the record labels, and 25%-30% in overhead including credit card fees and paypal charges. However, Apple deceptively made their money on the back-end by selling innovative easy to use hardware that focused on the power of the new mp3 format. This led to de facto mainstream market-acceptance for mp3 as a legitimate and powerful format.

The failure of the music business to capitalize upon the mp3 format and sufficiently monetize it has lead to the dramatic decline of its revenues year-over-year. The cascading impact has been that the major record labels have been struggling to create mega-hits due to the combined failure to monetize and leverage the mp3 format, with the decision by radio to abandon its classic role as the curator of public music tastes. Thus, the dream of signing a contract with a major record label became both far more remote and while also becoming far less rewarding.

In light of the resultant mp3 crisis, cash flows of the major musicians began to shift from recorded sales to more live performances. In reaction, record labels began to require a share of musician revenues from performances and live concerts.

Into the vacuum, a number of music sites have arisen based on an aggressive interpretation of the digital millennium copyright act of 1998. These are based around the claim that they could stream any music from an existing catalog as long as they paid a certain royalty per listener hour. A recently public competitor in that space operates outside of the exact legal mandate for non-interactive streaming, but is tolerated as they are a major source of revenue under that law. The really huge deal here is that record labels do not need to explicitly consent in advance to the streaming activity.

Music Industry Sales Data with Trends

The U.S. total digital music market grew to $3.2 billion in 2010, up 3% from the prior year. Digital downloads continued double digit annual growth reaching $2.2 billion, a 10% increase over the 2009 total of $2.0 billion.

Although digital download unit growth was only 2%, stronger growth in albums and the first full year of variable pricing contributed to the larger growth in value. Digital albums and tracks grew by value at 9% and 12% rates, respectively in 2010. Overall, digital formats comprised a record 47% of total music shipments in the United States in 2010. For comparison, digital shipments only accounted for 9% of the market back in 2005.

Distributions for digital performance rights, which include payments to performers and copyright holders for webcasting, satellite radio, and other non-interactive digital music services, increased 60% to $249 million in 2010. Performance revenues represent an increasingly important piece of the music industry landscape as fan interest grows in digital listening and access formats.

Overall shipments of recorded music in the United States fell 11% to $6.9 billion in 2010. Growth in digital formats only partially offset a decline of 20% by value in physical formats in 2010. The decline in CD shipments accounted for the vast majority of the decline on the physical side in 2010, though vinyl albums continued to be a positive note, growing in 2010 by 44% to $87 million in 2010—their highest level since 1990.

Mobile shipments (including ringtunes, ringbacks, and full length content) declined 28% in 2010 to $527 million. Ringtunes experienced a steep decline of 41% in 2010, while ringbacks fell 26% in value. Full track mobile downloads were down 23% (full track purchases made on mobile devices through online stores, rather than mobile content stores, are counted as digital downloads). In 2010, ringtones accounted for about half of the mobile digital music market, with 49% share of the category by value. Ringbacks remained at 20% of the market, in-line with 2009, while full length tracks and music videos grew to 31% in 2010 versus 19% the prior year.

The problems this invention comes to solve have perplexed the at its zenith a multi-tens of billions of dollar record label industry, in at least one case, for more than a decade.

### Internet Marketing Surveys

Classic internet marketing teaches to use surveys only on warm leads who have already registered for your email list. Moreover, they teach to get people to opt-in to an email list or a registration, and only then to take a survey. For example, click on a like button on Facebook to get a free report, deliver a free report and encourage them therein to opt-in again to get follow-up content.

In view of the foregoing, an object of the invention is to provide to provide improved systems and method for digital data processing.

A more particular object of the invention is to provide improved systems and method for building a customer base for a musician.

A more particular object of the invention is to provide—by way of non-limiting example—improved systems and method for building a customer base for a musician school students and corresponding alumni, whether from college, university or conservatory.

A still more particular object of the invention is to provide—by way of non-limiting example—improved systems and have application in internet marketing to support a live performance and/or educational delivery by encouraging writing reviews of the live performance without requiring opt-in prior to writing such reviews.

### SUMMARY OF THE INVENTION

Music schools increasingly over the past decade have faced the crisis of receding potential for their graduates to become signed by a major record label, and the decreasing rewards for those graduates who do get signed. While parents and their children invest an estimated $10.8 B annually at $40,000 per year for 270,000 students in music programs nationwide, in the current recorded music ecosystem these investments on average cannot return even their face value. These music students under the current ecosystem on average will be disappointed as sales of recorded music in the United States fell another 11% in 2010 to $6.9 billion. Thus, even the recorded music purchases in the United States were to consist entirely of music student seniors in their final year of music school study, there would not be sufficient revenue to cover the direct costs of even their final year of study. Thus, while 77.55% of music school students (according to my survey) intend to rely on music for their income, most graduates do not achieve that goal.

These observations of the contrasting investment in education with the declining sales of recorded music have not received appreciation in the prior art and some of their implications can be addressed in this and related applications.

Aspects of this invention provide an Internet-Assisted Method for Building a Customer Base of Music-School Students, and alumni thereof:
A method for building a customer base for a musician, comprising offering a discount on food or drinks at a venue where a musician plays or has played a piece of music to a listener who hears or has heard the piece of music of the musician, the offering is to be in exchange for the listener providing a rating of the piece of music of the musician or the listener providing a rating of the musician, accepting a rating by the listener of the piece of music of the musician or a rating by the listener of the musician. Optionally, offering at least one song of the musician for purchase to the listener who rated the piece of music or offering at least one song of the musician for purchase to the listener who rated the musician. Optionally, wherein the at least one song of the musician comprises the piece of music.
A method for building a customer base for a musician, comprising accepting a rating by a listener who hears or has heard a piece of music of a musician or a rating by the listener of the musician, wherein the musician is a music student at a college, university or conservatory, or alumnus thereof, offering the listener who rated the piece of music, or offering the listener who rated the musician, the opportunity to provide contact information of the listener. Optionally, wherein the contact information of the listener comprises an email address. Optionally, wherein the contact information of the listener comprises a telephone number. Optionally, wherein the contact information of the listener can accept SMS messages. Optionally, wherein the listener may receive information about future events. Optionally, wherein the listener may receive information about future events of the musician. Optionally, wherein the listener may receive information about future events of the venue where the musician plays or has played the piece of music to the listener who hears or has heard the piece of music of the musician. Optionally, wherein the musician can provide a newsletter to the listener. Optionally, further comprising offering at least one song of the musician for purchase to the listener. Optionally, further comprising offering at least one live event to the listener. Optionally, further comprising offering video or audio or newsletter content or software-as-a-service or software-to-download to the listener that provides value to the listener, and/or increases willingness to buy of the listener.
A method for building a customer base for a musician, the customer base, comprising accepting a rating by a listener who hears or has heard a piece of music of a musician or a rating by the listener of the musician, offering at least one song of the musician for purchase to the listener who rated the piece of music or offering at least one song of the musician for purchase to the listener who rated the musician. Optionally, wherein the at least one song of the musician comprises the piece of music. Optionally, further comprising offering the listener who rated the piece of music, or the listener who rated the musician, the opportunity to provide contact information of the listener. Optionally, further comprising offering the listener who purchased at least one song of the musician, the opportunity to provide contact information of the listener. Optionally, further comprising offering the listener who rated the piece of music, or the musician, the opportunity to join an internet-based membership site.
A method for building a customer base for a musician, comprising accepting a rating of a piece of music of a musician by a listener who hears or has heard the piece of music of the musician at a venue where the musician plays or has played the piece of music, or a rating by the listener of the musician, offering a discount on food or drinks at the venue in exchange for the listener purchasing at least one song of the musician, offering at least one song of the musician for purchase to the listener who rated the piece of music or offering at least one song of the musician for purchase to the listener who rated the musician. Optionally, wherein the at least one song of the musician comprises the piece of music.
Aspects of my broader innovation include requesting review of digital content and/or non-digital content by a consumer after exposure of the consumer to the digital content and/or the non-digital content, followed by consumer providing contact information. An example can include but not limited to review of a musician or or review of their music by a listener in real time at a live venue. However, based on market research, I have found contrary to common teaching that a digital content consumer such as a listener will be willing to join an opt-in list with a close to 50% probability without any additional opt-in incentive simply if first genuinely requested to provide a review. This is especially true but not limited to performing arts in live venues. Optionally, it could be for talks given at a conference. Optionally, it could be for a short teaching session. Optionally, it could apply to radio broadcasts. Optionally, it could apply to sales of digital content such as on-line teaching programs such as self-help or education. Currently widely available software such as wordpress fails to provide by default a tool that facilitates the flow from a rating or review to an opt-in, rather such tools are currently juxtaposed requiring the user to decide their next step.
   These and other aspects of the invention are evident in the drawings and in the text that follows.

### BRIEF DESCRIPTION OF THE DRAWINGS

A more complete understanding of the invention may be attained by reference to the drawings in which:

FIGS. 1-23 are flowcharts depicting operation of embodiments of the invention.

### DETAILED DESCRIPTION OF THE ILLUSTRATED EMBODIMENT

The NEC entrepreneurship department has probably the scope of the Music business one at Berklee, even if it is not officially integrated within the students credits. The department has to insert some classes about marketing or other tools to increase the musicians visibility within the already recognized credits by the student's program.

NEC is not really focused on the business side of the music. The school is strongly a traditional music school and the focus of the department is to make the students aware of the possibility to build their own traction. The school is only focused on music skills.

The average budget they can assign to the students is from 1000 to 1500 dollars and it does not have a specific focus. It can be used for external courses, flyers printing, or anything it can help them in a direction usually not covered by the school.

NEC is a traditional school. The majority, if not the complete, faculty still requires to send in assignment in a CD format. The course management tool is really providing basic services and for the first time this year is possible to apply online to the school. The IT department is not a traditional IT department but is more a sort of Computer expert department which helps the school with the technological problems using the system. The school has 750 students which pay a tuition of approximately 45,000 dollars including the dorm expenses. The school do not have an external relationship department apart from the person in charge of donations. The only providers they have should be the instruments one. There are relationships with companies providing the instruments to build few fully professional recording studios, but for the rest the school is not really focused on outside relationships. In general the structure of the school is slowly changing. The course management tool and the rest of the services are provided through the portal MYNEC, which is an extreme basic tool compared with the possibilities internet offers.

Optionally, for NEC I can provide a turnkey system that is external.

### About Music Industry

The students, apart from few well known as almost professional musicians, do not believe anymore in selling music through the labels. The problems identified are different.

Nobody buys music anymore and the digital revolution has changed the world. Today is rare a person buys a cd of an independent artist in a store and even rarer it buys a cd on the internet. On the common digital tools is really difficult to get discovered and requires an effort that is not rewarded by the revenues. The cut from iTunes is too high and it is so much better to sell music directly after the concert when the minds of the listeners are fresh about you and your music. Aspects of the present invention aim to assist the music school student, and eventually alumni, to be able to market their music directly and more effectively with the assistance of automated tools.

### Big Picture

Another co-pending application given a large number of quality music school students who contribute their music, and a large number of their fans listening to it regularly, classifies music according to its fan base and its popularity with that fan base.

Major record labels had 27,000 new releases a year (as of 2006). There are 270,000 music students in the United States. Assuming 5 songs per student. Given full market penetration, I can insert each new release approximately once every half an hour to an hour (e.g. every 10 songs). The algorithm in my co-pending application will automatically classify the new release music when the initial placement was correct. The new release can be placed by the new release artist at five separate initial placements. Over half of the songs so placed will receive definitive traction and a clear classification by listener demography, geographic location, and projected audience size. Those songs which fail to receive substantial fraction (are in the lower 50% of the total) will be recommended to the major record labels to not release without further testing.

Cary Sherman claimed in testimony for the RIAA that 9 out of 10 artists who get signed never make money. At the Future of Music Coalition conference Jim Cooperman of BMG claimed that a Major label act has to sell 2 million albums to break even. He also gave figures for 2002: 37,000 albums released; 257 gold (500,000+ USA sales); 121 platinum (1,000,000+ USA sales); 134 multi-platinum (2,000,000+ USA sales); So the situation is much the same as 1999, except that (according to Cooperman) only 0.2% of all releases break even. So the Majors in autumn 2005 average less than 3% profitability against a background of cost-cutting, mergers and staff layoffs. In my next example, I assume a 5% profitability to make the math more simpler.

Previously, the marketing and distribution costs of an average of $500,000 is typically invested before it would otherwise be clear the expected uptake of the new music. This tool can provide a substantial boost to profitability as record labels go to market only with the most promising of the artists and having a better sense of who their target audience will be and its size. For example, suppose that a record label currently spends $50,000,000 on marketing and distribution for 100 releases, and brings in revenues of $52,500,000. If, instead, by using my algorithm as implemented in the software system to identify the lower 50% of releases, without impacting the gold, platinum or multi-platinum releases, they could trim $25,000,000 off of their expenses. Even paying $5 m for my service, thus, the profitability would be $52.5 m−$30 m=$22.5 m profits on expenses of $30 m. This is the holy grail that got presidents of major record labels excited about my approach.

To achieve this magic that can transform the record industry into profitability, I need to build the community of music school students. While they appreciate an integrated system that encourages them to meet their peers, they are most hungry for a way to boost their personal music sales and are in most need of an automated tool to help them grow their music fan base.

Music students have difficulty playing in public. Half of them do not play and the majority do not play more than once a week during the school year. It is difficult for them to create insightful relationships with other students. Students are having difficulty meeting and getting to know each other well. Low involvement within the community aside from the school's assignments. Students would like their music to be sampled by others. On the music student path practice and feedback are relevant aspects to grow an artist. Students do not have any preferred place to listen to peer's music. 77.55% of Students plan to rely on music for their income based on a survey that I conducted among students at Berklee College of Music in Boston. Half of them do not have relationships within their school community apart from work study. Students seek to build relationships within the school community.

Students want their music to be discovered. Majority of students are willing to post for free. The majority who answered no will still post but would like to be compensated when the music is downloaded or played. Students believe there is no effective method at school of listening to music of fellow students despite limited opportunities provided by recitals, shows, and student concerts. The majority of students believe there are no methods provided to discover each others music. No dominant automated tool as alternative to live events was known to students.

Currently, students are forced to pay and choose for services which provide only partial solutions. The systems in place require multiple and different login information. Users need to make a choice and use the most suitable service for their needs. School provided services are not used and the school continues to pay for them. External services have an average cut of 30% on the student's music.

### A Sample Embodiment of the Present Invention, Optional Aspects Thereof—Internal

Social Networking part can include:
Ability to search for other music school students
Ability to forms groups or ensembles on line
Ability to post music, comments, assignments and events
Ability to be linked to other social networks such as facebook and myspace
Complementary Search
Event Posting
Music Review

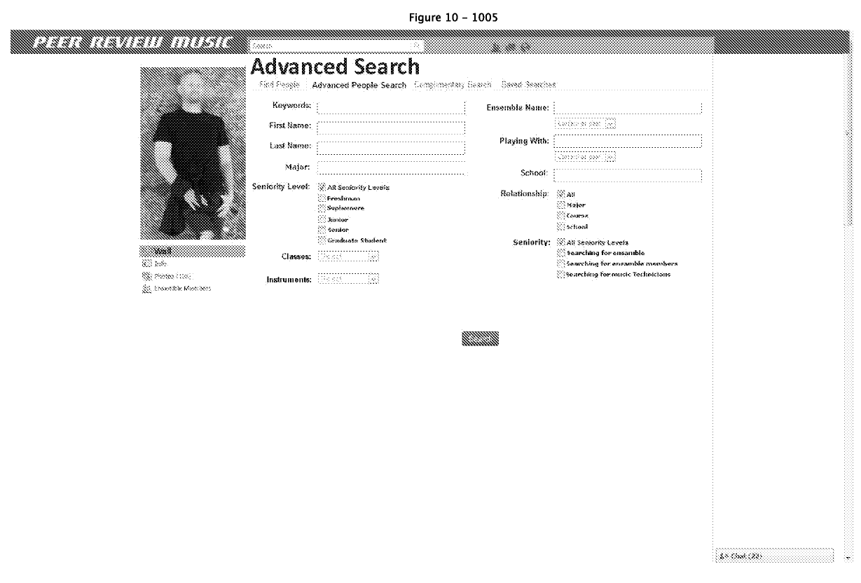

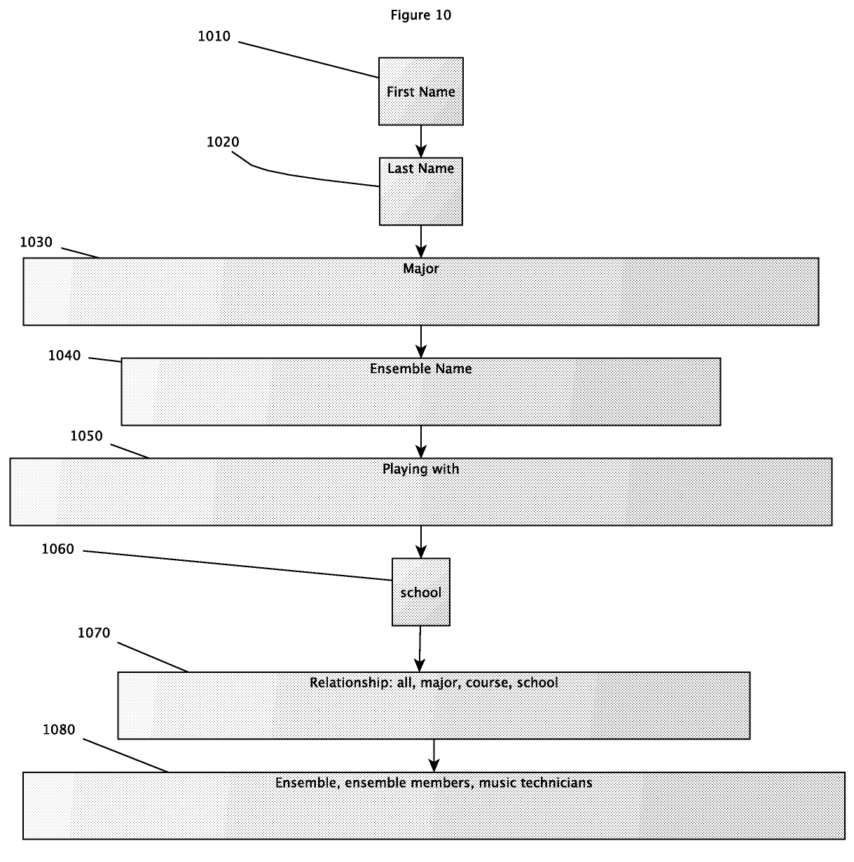

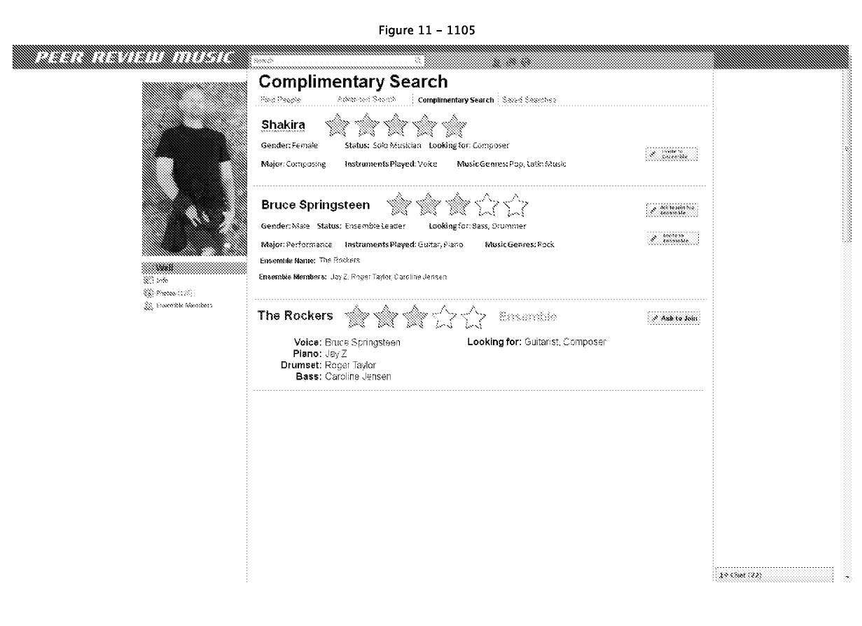

The internal social network optionally will increase relationships among students, increase visibility of the student work, and/or increase the number of reviews of that student and their music. (see FIG. 10.)

### A Sample Embodiment of the Present Invention, Optional Aspects Thereof—Public Site

Dedicated, easy, and mobile platform to receive reviews from the public
Ability for the public to listen to recorded events
Ability for musicians to listen to other artist's performances
Ability to purchase music from the artists onsite

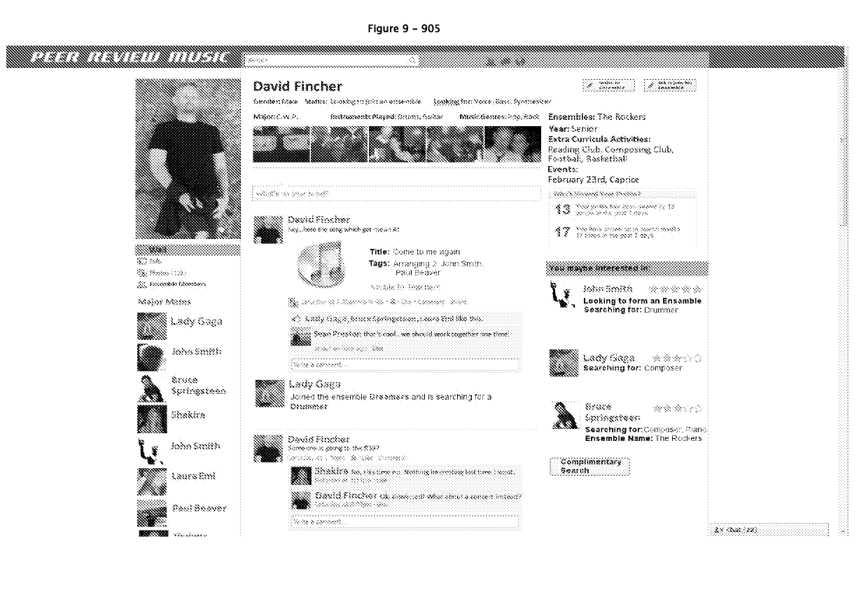

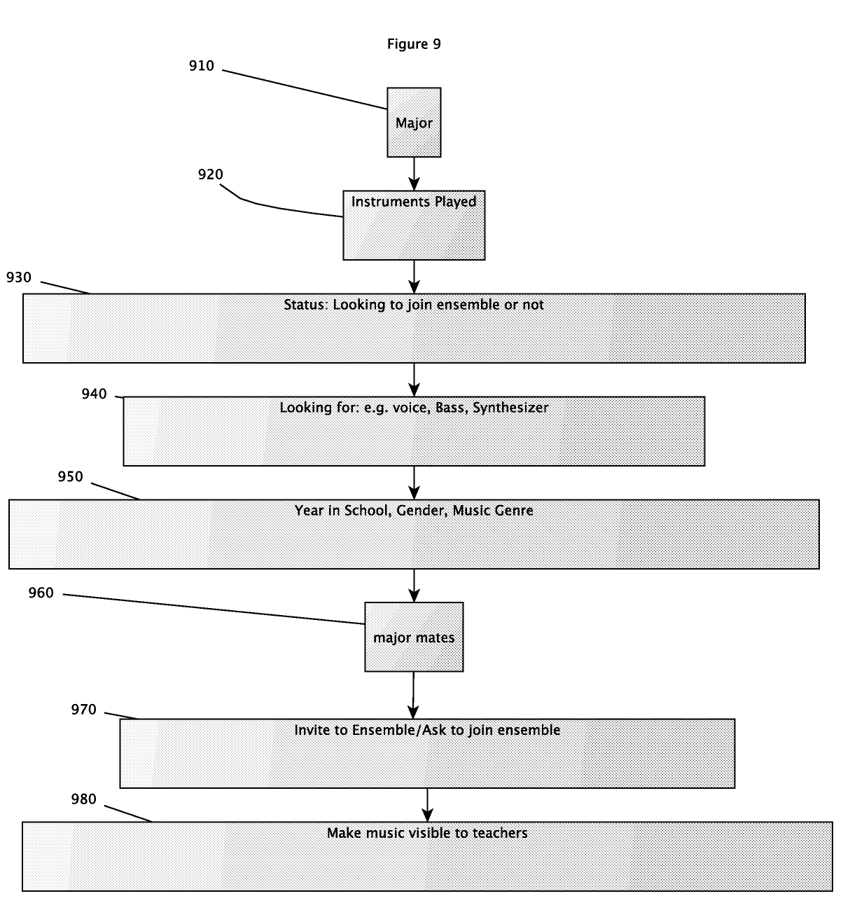

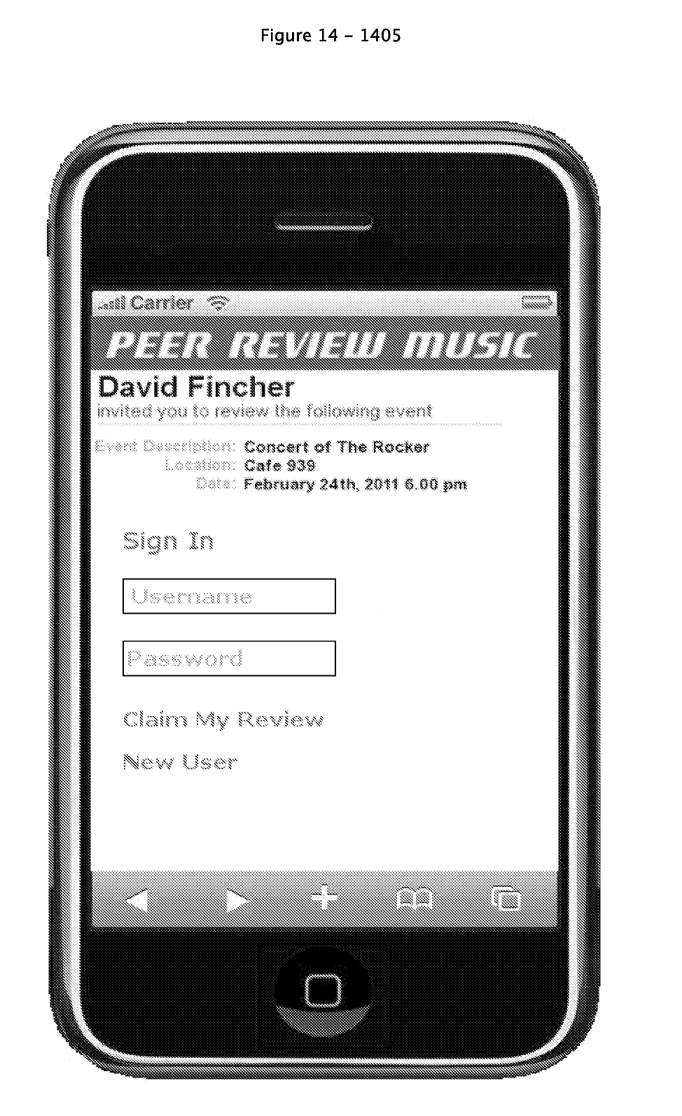

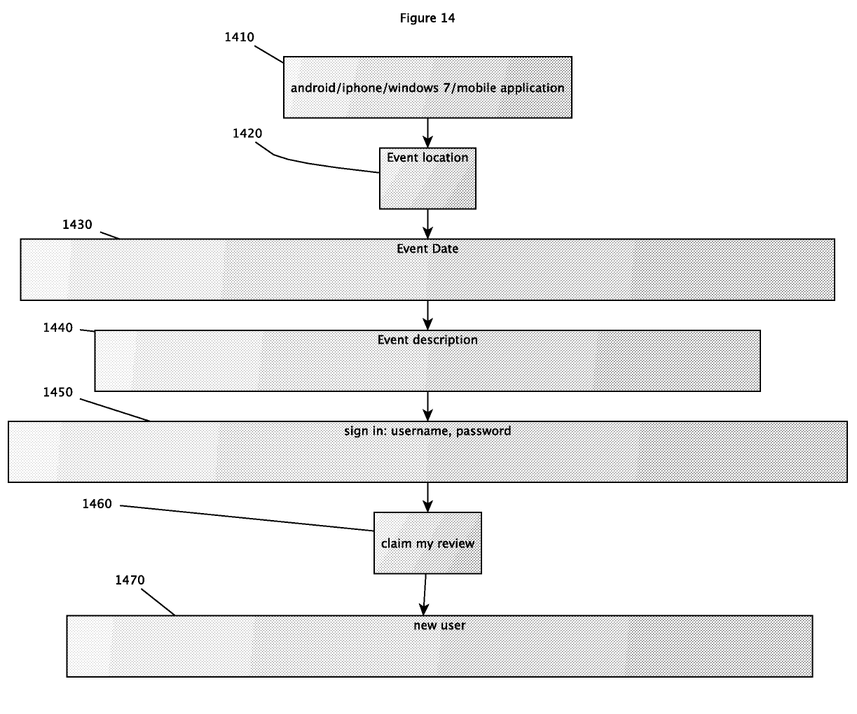

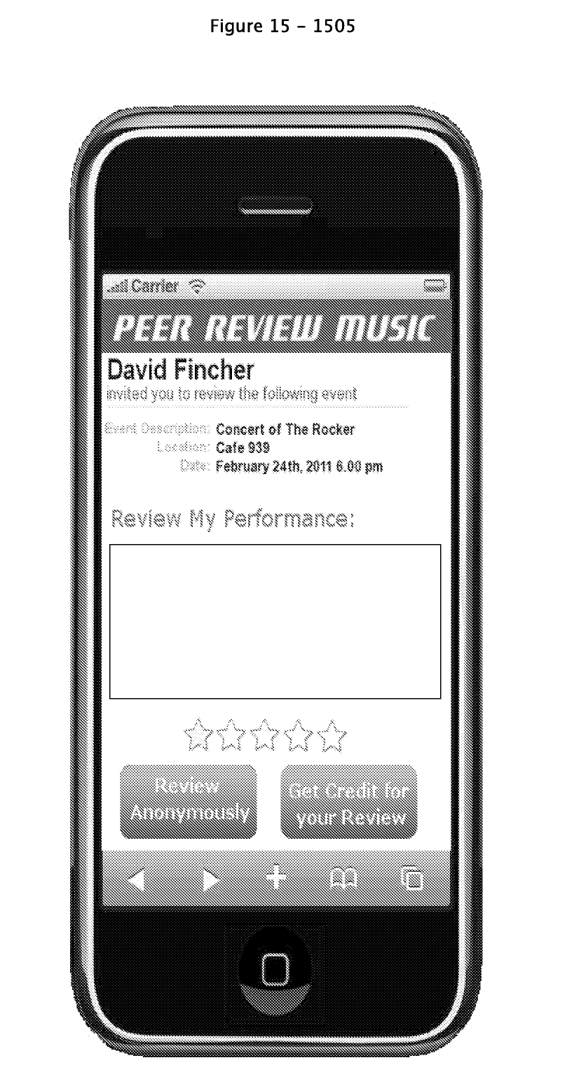

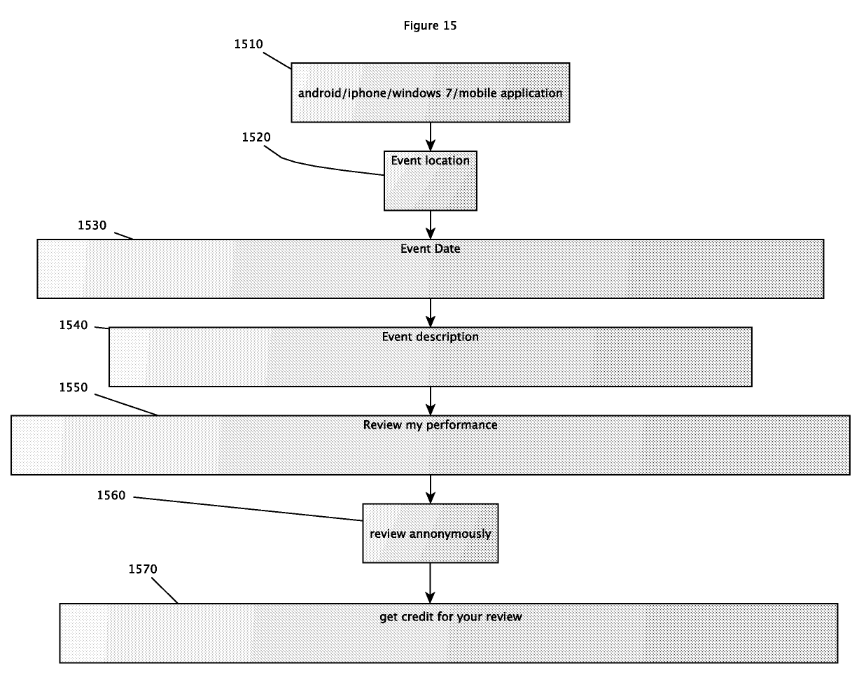

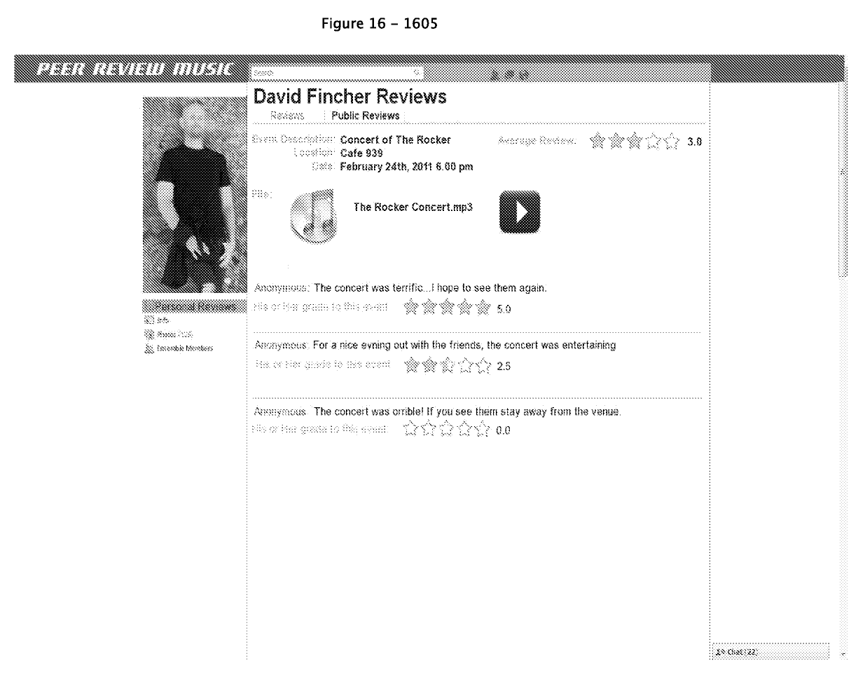

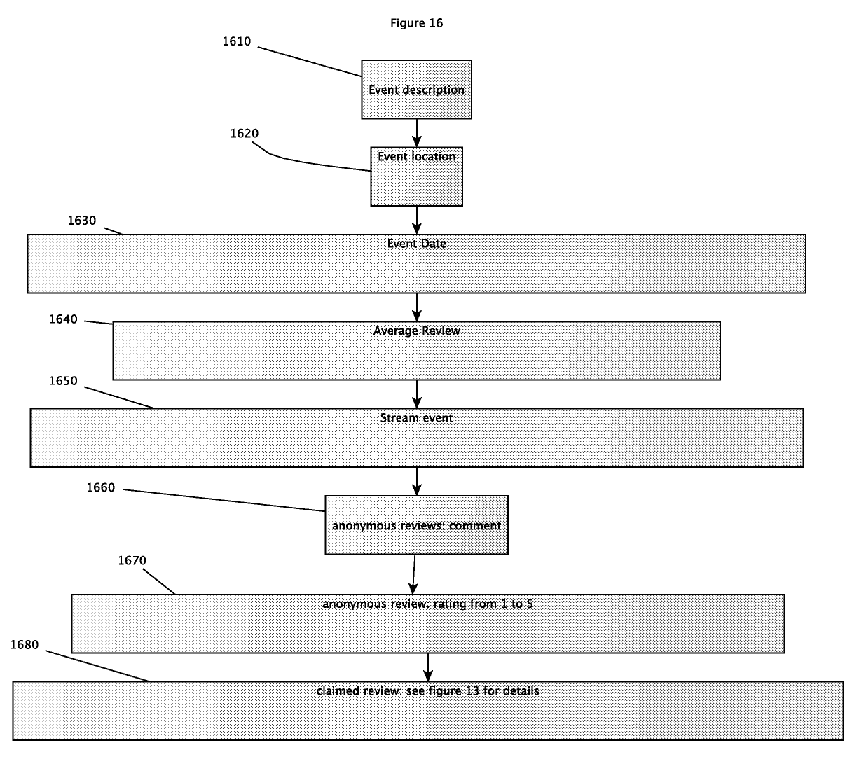

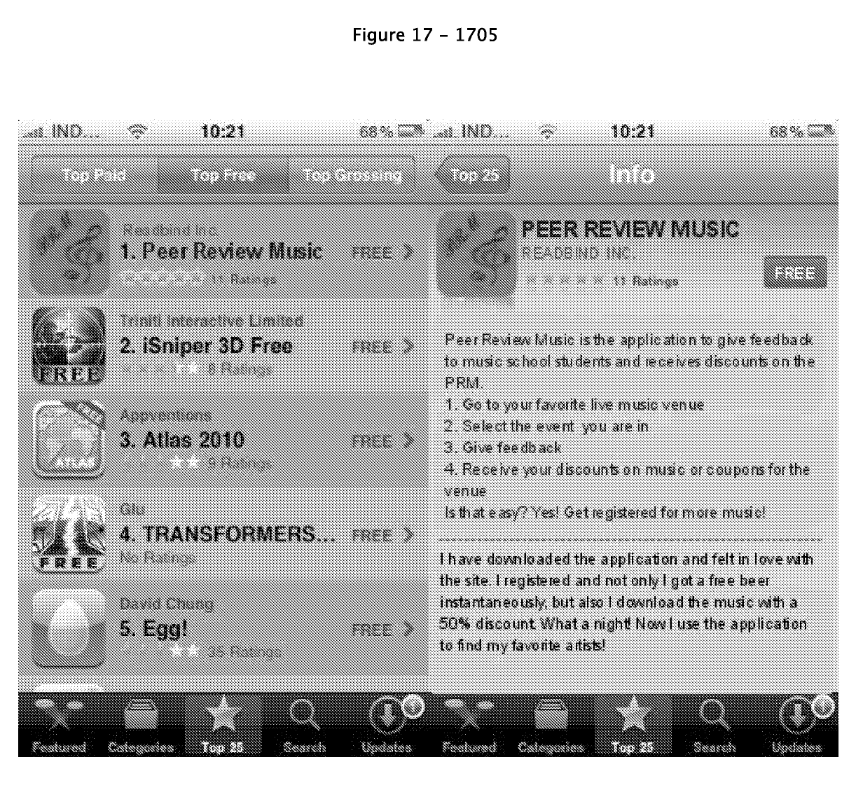

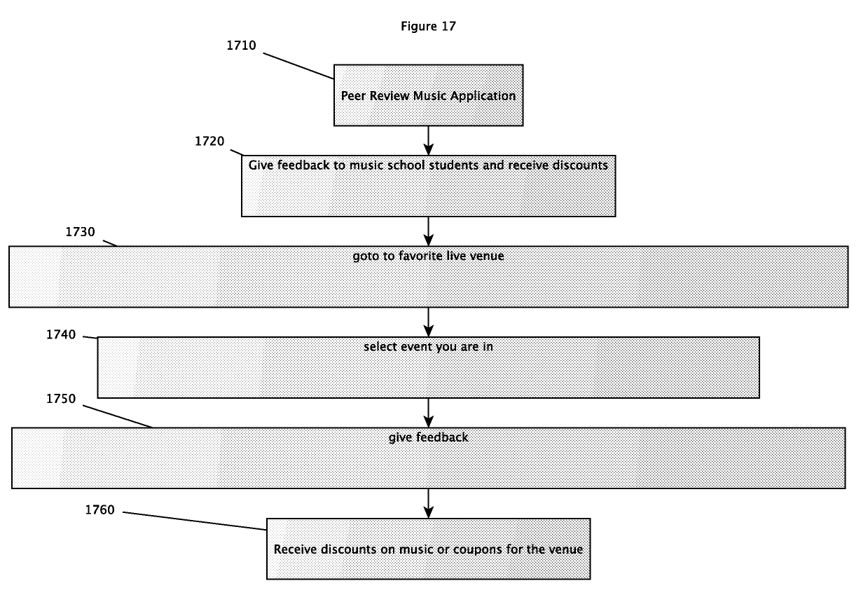

Optionally, public site review page will be available on mobile in a smaller and fast loading format to permit reviews directly on site. (see FIG. 14 and see FIG. 15) Public page to review the student performance. A mobile application will be available to facilitate steps for power users and students. (see FIG. 17) The public review site will permit re-listening to the performance as mentioned in the internal site. (see FIG. 16) The public site will highlight the music available from the same artist. Market research demonstrates a willingness to buy favorite songs of independent artists. Possibility to create promotions to spread music of students (discount for feedback or coupons at live venues). The site architecture is designed to enable transferring up to 100% of net revenues (revenues after cost of payment expenses) to students from sales of downloaded music. The system can be integrated with major online music stores. Optionally, with a single upload, for students their music is available for internal social networking site, personal external social networks, professors for grading, and/or the public review site for sale. (See FIG. 9.)

### Providing Massive Value to Music School Around the World & Launchpad for Nationwide Music Radio Network

Most Graduates from Top-Tier Music Schools
Give up on dream of being a professional musician
Songs placed on iTunes gather dusk undiscovered
Lack sufficient guidance on how to sell their own music

### Make Musician's Dreams Feasible

How can a music student sell their music while still in school and get feedback?
What is the process for a small nascent musician to build their own traction?
Can music schools promote student/alumni music to compete with iTunes?

### Because Great Music is Our Soul

How can a music student sell their music while still in school and get feedback?
   Distinguish talented musicians with a future
   Provides early momentum to overcome family doubt
   Music school enjoys a ratings boost because graduates have careers
What is the process for a small nascent musician to build their own traction?
   Places responsibility and capability with the musician
   Provides an alternative to iTunes but requires personal effort
Can music schools promote student/alumni music to compete with iTunes?
   Building on a network of music school students and their fans
   Behaviorally automatically organize music browsing to ensure niche quality listening experience while providing exposure for musicians

How can a music student sell their music while still in school and get feedback? (part I)
Musicians perform live in music venues
Cell phone carrying fans willing to rate music and musicians near end of performance
More willing to rate if given discount on drinks at venue
Those who rate are likely to purchase music if enjoyed it

How can a music student sell their music while still in school and get feedback? (part II)
Musicians perform in music venues (50%)
Fans go to venues to listen to music (92%)
Cell phone carrying fans willing to rate music and musicians near end of performance (58%)
Cell phone carrying fans would use cellphone to rate music (80%)

How can a music student sell their music while still in school and get feedback? (part III)
More willing to rate if given a discount on drinks at venue (63%)
Fans who enjoyed music want engage musician or venue (90%)
Those who rate likely to purchase music if enjoyed it (51%)
If not sure about music will buy with discount at venue (40%)

What percentage of music fans will purchase music?

### Scenario A:

(a) Listen to music (92%)

(b) willing to rate music for discount at venue (84%)

(c) will purchase music if enjoyed (51%)

Total: 92%*84%*51%=39% of listeners who enjoyed music will buy music.

Based on our market research this can represent a 10-fold increase in music sales after a live performance.

### Scenario B:

(a) Listen to music (92%)

(b) Willing to rate music (58%)

(c) will join an email list for either the musician or the venue (90%)

Total: 92%*58%*90%=48% of listeners who enjoyed music will join email list for marketing purposes.

### Scenario C:

(a) listen to music (92%)

(b) willing to rate music (58%)

(c) will purchase if enjoyed music (51%)

Total: 92%*58%*51%=27% of listeners who enjoyed music will buy music.

### Scenario D:

(a) listen to music (92%)

(b) willing to rate music (58%)

(c) will purchase music if given a discount at venue (71%)

Total: 92%*58%*71%=38% of listeners who enjoyed music will buy music.

### Concrete Results to an Unsolved Problem Optional Aspects of Embodiments

Build software as a service platform to enable cell phone based rating in the venue
Encouragement to purchase music if gave good rating
Provide ability to easily buy the music in the moment
Integrate capture of emails for future marketing by musicians and venues
Optionally provide discount at venue for rating the music (may not be in software)

Aspects of the present invention may optionally include building a sustainable business partnering with the most prestigious music schools of the planet helping them in creating the best environment for music students. Optionally, increase future chances of the music students to make a living with their artist career, giving them the tools to begin their career while still in school.

Optionally, to offer an integrated internal platform to permit the students to share their music, profiles, search for music partners, submitting assignments, and getting reviews from their peers.

Optionally, allow the students to gain visibility from the public, and their fans, offering an easy way to get reviews from the public during and immediately after their performance in a live venue.

Optionally, making their music available to market where against an annual fee, musicians retain the net revenues after expenses earned from sales of their music.

Trustworthy unsigned music. It is a myth that signed music is quality music and variety and that unsigned music cannot be trusted. Rather, singed music has a limited catalog, and aspects of this invention optionally enable musicians to innovate with depth and subtlety where the artist controls their final output, and/or a musician-friendly ecosystem with a sustainable business model, and/or leverages real-word brands and relationships to the benefit of the musician ecosystem. For example, optionally, musician relationships in academic communities, a music search tool, professional networking tool for musicians; optionally, academic, social and professional tool; optionally, revenue share with musicians.

Existing systems have a number of drawbacks such as no professional network, music not organized, disorganized, hard to find music without knowing the URL in advance, not organized for music students or music.

For example, optionally, trustworthy unsigned music, sustainable business model, long-term relationships, and/or revenue share with musicians.

Existing systems have a number of drawbacks such as slow & expensive, categorization, business model broke, USA only, limited to automobiles.

### Selling Strategy

Optionally, the best way to sell music is immediately after the concerts or to initiate a long-term relationship with fans. It is extremely difficult otherwise to promote your music and to sell it. Typically today the music on internet is posted for free to increase the musician fan base. The purpose is to bring more people and to have more followers at the events and to increase your chances of getting your music bought immediately after the event. In one non-limiting example, the selling price for his work is of 15 dollars per a CD (10 euro) for approximately 50 minutes hour of music. The cost to produce the CD plus the copyrights is of 2 euros (or 20% of the selling price). It is really difficult for him to estimate a number of people going to his events since he plays in different locations, from the small pub, to the stadium before a bigger name.

Optionally, the other and only way to make revenues before a label contract at the moment is Youtube. If you are able to become a Youtube partner (you need a certain amount of visits on your page and videos) you can take the following payments from Google: 5$ every 1000 visualization of your videos, 1 cent for every visit to your page, and/or 3 cents per subscriber. For example but not limiting, one student in 2 months was able to attract 40,000 visualizations and this is becoming more and more important, following the example of well known artists, who gets revenues from posting private videos on their personal youtube page.

### Tools Students are Using

The students are mainly registered on MySpace. the scope is to have your personal page published with your events and your music to sample. Since MySpace is losing traction, other sites permits you to sell music. The main scope of the personal page is to bring people to encourage them to get to know you better. After the concerts musicians may give business cards with the personal site and the MySpace page to get fans interested in his music. The site and MySpace give fans the possibility to listen to the music and to go, when possible, to a live event. Optionally, these are features that aspects of the present invention can implement together with a drive to become the most used tool within the music school's boundaries. Optionally, the adoption within the school is fundamental to spread the usage within the musicians. If the majority of the people are using the tool, at this point is important to be in there. Many musicians today use Facebook to invite people to the event. Currently, musicians cannot easily track and do not track people coming to the event, rather they just send the invitation to all the contacts they have and post it on their page and site. Currently, the only way to judge a performance is based on the number of cd sold and the number of people coming to congratulate at the end. Optionally, these are features that aspects of the present invention can implement together. Within the school there is no a dominant tool used to increase relationships between students at music schools. The tools available are the internal social network and the Campus Cruiser. The internal social network is not used by the majority of the people. Since the users' number is low there is no clear reason to use something smaller than the external tools they already have. The tool is too isolated and does not cover their needs. Campus cruiser is to manage classes and calendars. The majority of the professors do not use the tool for assignment submission and at this point there is no automated tool for that. Optionally, these are features that aspects of the present invention can implement together.

### Relationships

Relationships are essential in the music industry. Musicians plays a lot thanks to his relationship skills since they are often called to play. The main point is: you never know who is going to call you in 5 years from now or who is going to remember you once he is famous. They usually has a support role and they keeps the door open to the majority of the other musicians. To create an ensemble the most important part is the previous relationship or the social relationship you have with the other members. It is important to know if the people are reliable during rehearsal and you can go along with them. The most important part is the character, since it would be impossible to work with a person that you can't really talk to. The second important aspect to join an ensemble is the ability to get dates and people to the event. The organization part is really appreciated and even shows flexibility. There are students really able to perform live and to organize everything and you want to work with them because they make easier for you to perform. Music skills are usually in the last place since you already know, apart from the few stars within the school, that the quality level is good enough. From a musical point of view, after the first year, you do not really look at the music skill aspect. Even more at the beginning music skills are definitely in background and for shy people is difficult to have their music listened to. On the other side the few stars within the school are mainly known and their visibility increases the chances for them to get requests to join ensembles. They can have possibility to choose, for the others is more difficult to create the perfect ensemble and is rarely based on music skills. Usually students play in more than a one ensemble depending from the role he is able to take and from his relationship skills. Optionally, these are features that aspects of the present invention can implement together.

Optionally, this tool can really help the students in creating a strong network and public site reinforcing the quality aspect. Moreover the problem of finding other students, to join or create the best possible band, is completely satisfactory of the needs. The complimentary research and the possibility to listen to peer's music cover two big problems he has within Berklee:
Difficult to get to know all the students within the school and extremely difficult to listen to their music. You usually do not get in contact and you cannot listen to their music online. The only way are the live performances which sometimes are “in-class” performances and then your network is limited within your classes and friends.
Difficulty to join bands and to form coherent ensembles. The search tools will permits to know people within the school that are perfect match for your status. Then you can listen to the music on their page or to have a look at their review to understand if it worths a try. This can be really helpful.

The integration within the school system is important since at the moment the tools are not used due to this problem. He suggests to include a youtube integration, which is now considered extremely important. The Alumni retention in the system would be really helpful since there are no relationships with the alumni and this would permit to discover possible partners outside the school. Alumni will definitely increase the network effect of the Berklee brand. Optionally, these are features that aspects of the present invention can implement together,

Even the possibility to search within other schools can be a strong feature and create a strong advantage in case of multiple schools within the system in the same geographical area. The relationships with other music schools are not a big part of the experience. Optionally, these are features that aspects of the present invention can implement together.

Aspects of the present invention may include a personalized on-line music radio station for peer-reviewed music. Aspects of the present invention may include a predictive engine that selects the music to stream to each listener based on how their listening behavior compares to that of others in the community.

Optionally, deliver a new capability to the music communities to enable listeners to discover music of music community affiliated musicians and to monetize music community music.

The music industry disenfranchises both unsigned musicians and their listeners. It deprives musicians of a way to reach listeners with preferences their music matches, while denying listeners reasonably practical access to the depth of unsigned music. Unsigned artists face tremendous challenges getting their music heard and adopted even by independent labels.

Optionally, aspects of the present invention serves the community of tens of millions whose listening preferences include unsigned musicians. Optionally, my personalized internet radio service delivers unique value to listeners by learning their preferences and automatically selecting the next song to match. Optionally, listeners will be rewarded for using my system by influencing, through their listening behavior, which music is released.

An aggressive projection by Harvard Business School Professor Felix Oberholzer-Gee estimates our revenue potential to be in the billions.

Optionally, unlike competitors' failing approach using the explicit or implicit rating of songs by the listener, optional aspects of the present invention are based on the implicit evaluation of the transitions between songs using machine learning. It provides at the same time a better listener experience to motivate the listener to cooperate tacitly while interacting with the system and a more accurate prediction of success for individual songs, as well as pertinent and non obvious connections between tested songs and proven ones.

Optional aspects of the present invention are centered around a next-song next-hit optional aspects of the present invention learning machine with two combined tasks: (1) it proposes the best estimated song transitions to listeners based on their past behavior and streams the content; (2) learns based on listener behavior and past sales data, what to expect in future sales of individual songs. These two tasks are faces of a single algorithm using recent results in Machine Learning and Reinforcement Learning. This algorithm has a physical implementation in the prototype of the web application.

Research at Boston University supports feasibility in terms of computation power, size of the database and bandwidth. It has concluded that there is no major technical obstacle.

### The Next-Song/Next-Hit Engine

Optional aspects of the present invention's next-song/next-hit engine is built upon the theory of Reinforcement Learning used in Behavioral Robotics. Instead of recording and processing listeners' song ratings, the algorithm learns the values of transitions between songs. I use a reinforcement learning algorithm that makes each individual on-line player to transition towards songs most likely to be accepted. The engine learns automatically from the past sequence of accepted, chosen or rejected songs and what is learned from one listener is then automatically shared with the players dedicated to listeners of similar sensibility, similarity measured from the past behavior of each of them.

Optionally, The rating of transition is more detailed than song rating systems used by competitors. Optionally, it also improves the listening experience: the listener has the ability to navigate on the whole catalog and the algorithm learns about the listener acceptance, rejection and choices.

Optional aspects of the present invention track listener behavior when listening to music off-line. Optional aspects of the present invention are a small footprint software wrapper electronically enveloping music files. After a listener plays a song wrapped in our software, the listening habits and all music files present on a play device are reported to our database when the listener connects to optional aspects of the present invention. The optional aspects of the present invention cryptographic engine provides digital rights management for pre-released songs, and tracks content dispersion among music listeners.

Optionally, use sophisticated cryptography to provide accurate information while maintaining end-listener privacy. Optionally, once installed on a local device, optionally track listening habits to optional aspects of the present invention-provided music and to any other music.

Optional aspects of the present invention revenues come from its ability to provide the record labels with a statistically valid prediction on the success of individual songs. The next-song/next-hit engine determines the chances of success of any possible transition it proposes to listeners. Optionally, the system extracts the information and packages it in a compact form and in real time to the song providers and the music industry.

Optionally, the curves over time of the rejection and acceptance rates. This information pictures the “life” of a song. A successful song will have a growing acceptance rate inducing an access to an increased audience, and subsequent new opportunities to gain a favorable acceptance. The unsuccessful ones will simply “die” when all transitions to it will be progressively cut by listeners. A given song may well have to “migrate” from a class of the audience to another until reaching its favorable niche and it can be recorded in real time.

Optionally, the profile and the size of the favorable audience. The profile as to be understood in two forms: the first in the traditional classification by age, gender, location of residence, etc, and the second, presumably more interesting, a compact picture of the taste of the audience, that can be extracted from the transition table defined above, and will have the form of a limited list of known songs, to be understood as the “signature” of the class of the audience.

Optionally, a music player where the music is played by streaming or after download in the off-line version (in-vivo technology). The current playing song links to additional information like events, bio related to the artist. The listener can skip, replay, bookmark, rate, recommend, etc the current song. The algorithm gathers this information to improve future next songs for a given listener its neighbor in the sense defined earlier.

Optionally, a short list of the most probably acceptable next songs as decided by the algorithm. The listener can either pick a song or let the robot choose the default next song.

A personal page for listeners for creating their own playlist and communicate with peers.

A page to upload unsigned musical content to receive in real-time the analytic feedback. For a fee, we forward our analysis to record labels with additional comparison within peers.

Optionally, my initial target community is U.S. college students and alumni between the ages of 17 and 28. The college-affiliated/alumni demographic is a more educated, and more Internet-ready group. These will be the leaders and influencers whose enthusiasm will spread to their parents, relatives, friends, and people of other backgrounds with whom they come into contact. This is the market that the Recording Industry Association of America has lost and is continuing to lose, costing the commercial music industry $10 B (ten billion dollars) a year in revenue and its future.

Optionally, target music communities where listeners and musicians congregate. These communities exist, but have not yet established a meaningful web presence. I can offer such communities a website together with the ability to explore music of their own community, and optionally to explore music of other communities as well. I initiated contact with such music communities and have received ecstatic feedback. I plan to become the dominant aggregator of music communities.

Optional aspects of the present invention offers all of these opportunities to unsigned musicians. As Berklee College of Music Professor Billy Thompson said in reference to Jazz in Boston, “Your can't survive locally playing our type of music.” optional aspects of the present invention empower musicians by helping them locate fans. To seed my initial set of unsigned musicians and listeners, I plan to partner with 900 music schools throughout the United States and recruit their students to sign up for our service. Market research at the Boston University School of Music shows that well over 20% of the music students post their music to my web site. Those musicians become our initial audience base, which expands as they recommend my site to their friends throughout universities nationwide. I expect this strategy to initially attract 54,000 musicians to optional aspects of the present invention who will provide the seed content and listeners.

Music schools in U.S. (Source: University of Alabama) >900

Musicians per music school (# Students at U. of A.) 300

Music students in U.S. (schools×students/school) 270,000

Estimated market penetration (BU market research data) 20%

Student Musicians likely to post music on my website 54,000

With the following viral marketing attributes, optional aspects of the present invention can grow exponentially from colleges with music departments to the broad range of colleges and onward to alumni and other social networks connected with college students.

Optional aspects of the present invention's performance and website are designed to drive viral growth in listeners. The key viral marketing features are:

One-click to start enjoying the optional aspects of the present invention internet music stream

Optionally, the site is initially free to listeners and paid for by the school for affiliated musicians

“Uncanny” ability to pick music of interest motivates listeners to tell friends

Listeners recommend music to friends, that is heard on optional aspects of the present invention

Listeners share their optional aspects of the present invention preference profile with others

The unique listener preference data optional aspects of the present invention compiles provides unique opportunities for social networking; it enables listeners to search for music seamlessly and to learn from the listening patterns of other listeners, and to connect with such listeners with similar preferences.

Optionally, As I develop my community, I continue our research on product requirements for the major music labels. Through established executive level contacts at the major labels, I can develop relationships with managers at all levels of the selection and approval process. These relationships will be used to fine tune my product attributes and to ensure that proposed changes from my music communities won't conflict with the needs of the music labels.

I focus on building relationships with two or three lead music colleges whose requirements will guide our product enhancements to ensure it offers the listener value necessary to support viral growth in our target community. Please discussion elsewhere herein that discusses specific encouragement and progress towards such collaboration with people at Berklee and NEC. The initial target colleges are the music programs of leading colleges in the Boston area including: Berklee School of Music, New England Conservatory, Boston University, and Northeastern University.

Optionally, I can offer these colleges a customized Beta version of the optional aspects of the present invention web service for a non-recurring engineering fee to cover development expenses. The colleges and deal terms will be selected to ensure the maximum number of listeners will be driven to the optional aspects of the present invention site. Lead colleges and listeners will understand that as a Beta listener, they will have greater impact on the music of participating musicians and the operation of the optional aspects of the present invention service.

Optionally, during Beta phase, I test the effectiveness of the service and specific features. Developing awareness and listener interaction within the Beta community. Optionally, I collect listener feedback. During the Beta period I will have built a well-recognized, active community that will provide ample evidence of benefits from my service to potential listeners. This will ignite viral growth supporting a doubling of optional aspects of the present invention listeners in the Boston area each month.

After the Beta period I will build relationships with between 30 to 50 colleges in select major cities. Depending on budgeting cycles, I expect to close deals with between 10 and 18 colleges. Once I have a year of successful track records with the initial colleges, I expect our marketing will be simplified to scale nation-wide.

I will measure our progress with viral marketing measures including the following:

Number of Listener subscribers to optional aspects of the present invention

Average minutes per day Listeners use optional aspects of the present invention

Number of Musician subscribers to optional aspects of the present invention

Average number of songs submitted by musicians per month

Number of colleges using optional aspects of the present invention

Music Labels subscribing to optional aspects of the present invention services

% of target community subscribed to optional aspects of the present invention

% of target community within a specific metropolitan area

Number of mentions of and articles on optional aspects of the present invention per quarter

Optional aspects of the present invention revenue from labels, advertisers, colleges, and other

Optionally, I will use this data to guide marketing activities and product roadmap. The data will also provide the leading indicators necessary to secure funding.

Optionally, next step is to create a convincing customer presentation, including a canned demonstration, and engaging lead colleges. After closing deals with the lead colleges, my offer will be standardized enabling business development to scale.

### Markets

Optionally, Record Labels want failure prediction before song releases, unsigned musicians want to find their audience, and listeners want an easy way to find new music they will like, and hear it care free. Optional aspects of the present invention is the service needed to bring the music industry to the level of efficiency and predictability it needs to thrive. Optionally, I align with the listener willingness to cooperate unconsciously but massively while navigating between songs and I sell the record industry the statistically valid predictions they need. Unsigned artists get an opportunity to reach their public and being validly recommended by me to the record industry. I become the kingmaker for the music industry. “optional aspects of the present invention is for the music fan who wants to change the way the music industry makes decisions, decisions that are finally based on true fan input,” according to Sony's Seth Cassel.

### Present Market

Music Industry revenues rise until 6/99 when they plunge from $40 B annually to $30 B in 2006. Source: “Hitting a Sour Note,” Forbes, 6 May 2005.

“Our business models are under siege . . . record labels are still trying to figure out the digital business model . . . disruptive technologies hit music first and hard. It is turning the business models upside down; meanwhile the music industry has lost billions in revenue. We have to make the user's experience of getting music more interesting.”—Andrew Lack, Chairman of Sony-BMG, at Harvard Business School Apr. 8, 2006. Interviewed by Seth Cassel of Harvard Business School.

Any 10% improvement in failure prediction is worth $1.2 billion annually.

Market research at Harvard Business School suggests that record labels will pay $50,000 (10% of the average album's marketing budget) on a per-release non-exclusive basis for my behavior-based predictions. Field interviews at Harvard Business School with several record label presidents and chairmen suggest that $50,000 may be a conservative estimate for the value my product delivers. The Record Industry Association of America (RIAA) says the labels launch 27,000 albums per year, which translates into a $1.4 billion market for optional aspects of the present invention. I know senior level major label executives personally from years of working together.

“Record labels are struggling to identify methods of mitigating the risks of new product launches and better understanding the listener as their margins are continually squeezed and they lose entertainment dollars to competing media. Large radio companies have come to realize that nationally distributed playlists do not suffice, and the listener will tune in longer and more frequently if her localized musical tastes are met. For these reasons, a product that can predict the listener's receptivity to pre-released music and identify the listener's taste within specified geographic, demographic, or psychographic boundaries—optional aspects of the present invention's product—appeals greatly to these music companies.”

There are over 2,000,000 unsigned musicians seeking to gain spots in the 27,000 annual music releases that in turn vie for an estimated 2,700 slots in radio airplay. Only 10% of released music is profitable. Less than 0.675% of formerly unsigned bands release profitable major label music each year.

“Collecting data based on the activities occurring in this arena enables optional aspects of the present invention to provide value to record labels, for whom such listener taste information based on empirical behavioral data is incredibly valuable and hard to obtain. Record labels and radio stations have begun to question the accuracy and efficacy of the existing market research tools they employ to make decisions regarding albums releases and marketing expenditures in the case of record labels, and programming in the case of radio stations.”

### How the Record Labels Invest in Breaking New Musicians

Our CEO conducted an in-depth on the record interview with a regional CEO of a major record label. The following is a summary based on an approved three-page version.

Most of the money spent by the record labels is in trying to break new artists and constantly failing. Executives go their whole careers without breaking an artist. Developing artists has required that music companies invest and loose a lot of money. Nine times out of ten attempts at developing an artist will result in a financial loss. A record label considers itself successful if it succeeds that tenth time. To succeed, the artist must produce several good albums; they must be consistent.

There are three types of artists. There are broken artists on whom the record industry spends less in marketing and knows how to calibrate the marketing spending. The label has a shot at bigger sales. Another type is established artists, the record industry already lost money on the first one or two records, but they learn what will sell; they will likely not lose money on an established artist. The third type is unbroken artists.

The cost structure for a typical CD comprises recording costs as ⅓ of all expenses, marketing as 50% of all expenses for developing artists, and manufacturing, copyright, royalties accounts for remaining 17%.

Demonstration recordings “demos” of a full album cost ⅕ of cost of a full quality recording. Half of the work to make a demo can be reused in a recording. Demos are not mixed and not mastered. To an untrained ear it does not sound very different. Yet, it is perceived as lesser quality. The demos may use computers to simulate instruments. Some people can tell and musicians want to make best recording possible. Poorer recording quality sells less. As recording costs are ⅓ of all album expenses, and demos cost ⅕ of the amount of a recording, it costs a label 1/15 of its album expenses to do a demo.

A system that could answer based on just demos whether an album would be profitable would test a factor of eight times the music. For every ten albums released today, supposing the expense budget of five of them went to produce demos. Each album budget enables the testing of 15 demos. Assuming our system can select the best five demos out of the group of 5×15=75 attempts, the remaining half of the album budget would be spent on releasing those five. The system would only need to find hits with a 7% chance, which is less than the industry average today of 10%. Yet, the record labels would yield five times as many hits for their investment. Thus, their revenues should grow fivefold.

Alternatively, for every ten albums released today. One album budget would be spent on testing 15 demos. Assuming our system can select one of those demos to accurately predict a success, another album budget would be spent release it. Thus, the record labels would cut 80% of their marketing and distribution budget, while maintaining the same number of hits.

Everybody thought that the ability of record label A&R executives to predict successful artists was due to gut feeling of what people wanted to hear. The success of the industry was more due to ensuring that only artists the labels wanted to sell got promoted. As an industry people only saw artists the labels wanted to promote. Currently the way record labels select music is gut feeling. By the time they do the testing, the album is already out there.

A study at Harvard Business School suggests that the Artists & Repertoire (A&R) department in each music label currently sets substantially similar Marketing and Distribution (M&D) budgets for successes and failures because it lacks the ability to predict success or failure. In the words of Steve Greenberg, President of Columbia Records, you have to believe in the music you put out, “you fail with the ones you love.” He says no record label would sign a new musician unless they believed that musician would produce successful music. Our value to the industry is far greater as more CDs produce profits and labels will know which unsigned artists to sign and which signed artist albums to release.

### Real Networks Board Member: Hundreds of Millions in Revenue

Given effective predictive risk mitigation tools, the record industry will eagerly embrace expenditures in the hundreds of millions of dollars over time to save them billions according to Eric Benhamou, a Venture Capitalist on the board of Real Networks [MIT IAP, 2006].

### Harvard Business School Professor: Billions in Revenues

Harvard Business School Professor Oberholzer-Gee8 says that it is realistic for optional aspects of the present invention to capture 50% of the value created by optional aspects of the present invention thus yielding a total available market in the billions. [Meeting, February 2006]

The record industry desperately needs reliable predictive market research tools, yet the recording industry currently leverages a considerably limited offering of historical and emotionally biased market research tools. Products available fall into two main categories: post-release monitoring services and analysis, and customer surveys and analysis.

Post-release monitoring services comprise companies that monitor the sales, airplay, and claim to monitor “peer-to-peer downloads” of recorded music.

The music research tools market is rapidly growing. Ironically, these market research tools only marginally serve the fundamental purposes of market research: to mitigate the risk of new product launches and improve the return on product marketing expenditures.

In contrast to other services tracking audience purchases, in-laboratory activity, or peer-to-peer searches on file-sharing networks and file-sharing offerings, our service tracks actual audience listening behavior in natural settings. Competing services track music acquisition. However knowing that a person has acquired music does not provide information on their music playing patterns. This information can tell the industry which tracks on an album were hits. Purchase histories document failures, but do not prevent them.

“Existing services do not provide music test-marketing services where the listener listens to the music in a natural listening environment. This is optional aspects of the present invention's unique value proposition to record labels. Traceable, accountable data mined from listeners in their natural listening environment should provide insight to record labels that enables them to connect with listener tastes and demands more closely and accurately than the current tools afford.”

“The record industry needs market research services that observe music listening behavior in a natural way, provides information on the listener musical identity, and provides information on the market's receptivity to the product before all the marketing dollars are out the window. At this point, no solutions to these three concerns exist.”

Optionally, my approach uses the reinforcement learning approach that evaluates transitions betweens songs. Each user is associated with a dedicated robot that learns how to provide good music to its user while cooperating with other peer-robots.

### Operation of the Illustrated Embodiment

It is clearly understood that steps involving a musician, a venue, and/or a listener are not actually part of any of the disclosed embodiments of the present invention, but rather provide background and inputs thereto. For example, step 110 and step 120 are not required for infringement.

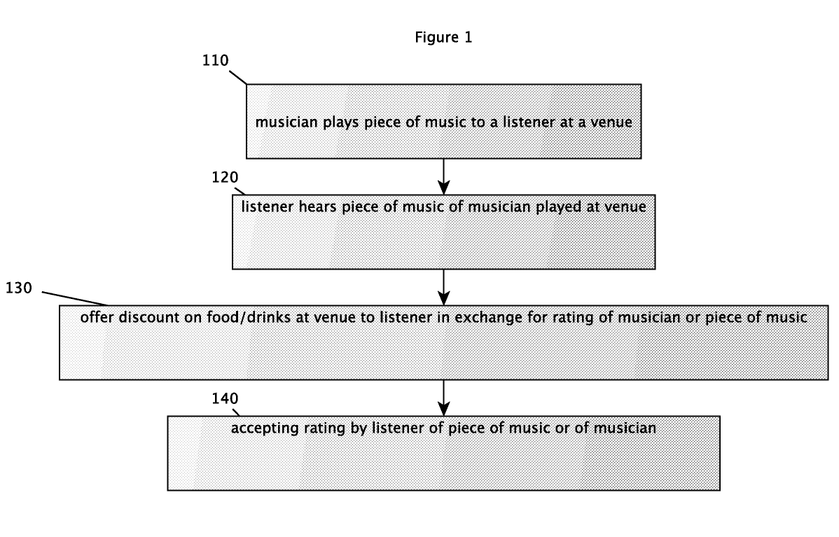

FIG. 1 is a flowchart depicting an embodiment that offers a discount on food and/or drinks at a live venue in exchange for listener rating of musician or a piece of music. A method for building a customer base for a musician. Step 110, musician plays or has played a piece of music to a listener at a venue. Step 120, listener hears or has heard the piece of music of the musician. Step 130, offer a discount on food or drinks at a venue, the offering is to be in exchange for the listener providing a rating of the piece of music of the musician or the listener providing a rating of the musician. Step 140, accepting a rating by the listener of the piece of music of the musician or a rating by the listener of the musician.

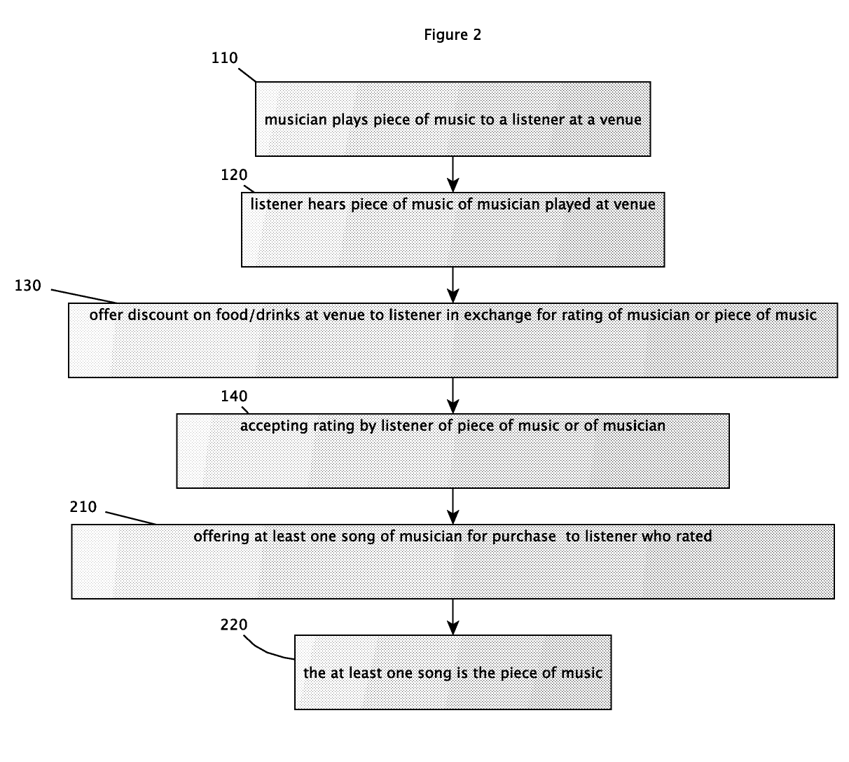

FIG. 2 is a flowchart depicting an embodiment that offers a discount on food and/or drinks at a live venue in exchange for listener rating of musician or a piece of music. Step 210, offering at least one song of the musician for purchase to the listener who rated the piece of music or offering at least one song of the musician for purchase to the listener who rated the musician. Step 220, wherein the at least one song of the musician comprises the piece of music.

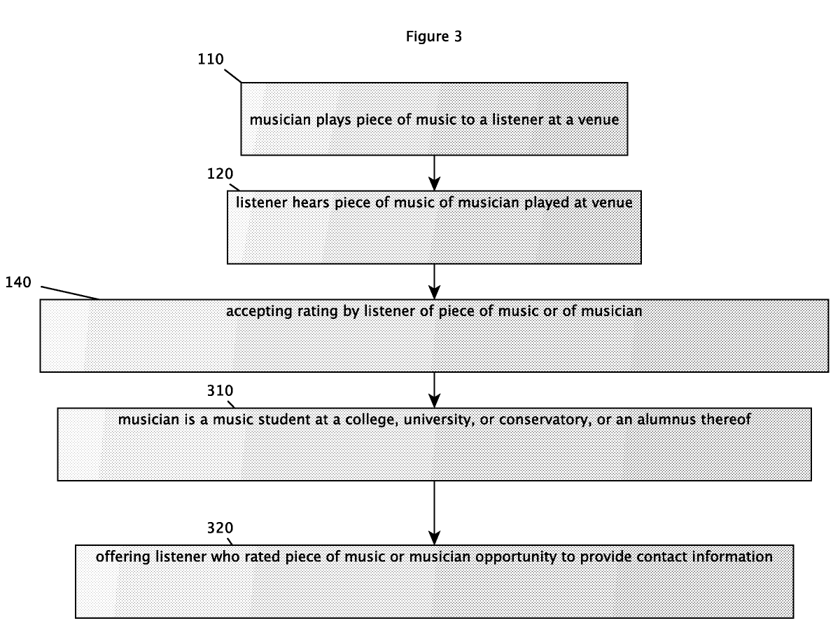

FIG. 3 is a flowchart depicting an embodiment that accepts a listener rating a musician or a piece of music, then offering the listener who rated the musician or the piece of music, the opportunity to provide contact information of the listener. Step 110, musician plays or has played a piece of music to a listener at a venue. Step 120, listener hears or has heard the piece of music of the musician. Step 140, accepting a rating by the listener of the piece of music of the musician or a rating by the listener of the musician. Optionally but not limited to wherein the musician is a music student at a college, university or conservatory, or alumnus thereof. Step 320, offering the listener who rated the musician, the opportunity to provide contact information of the listener.

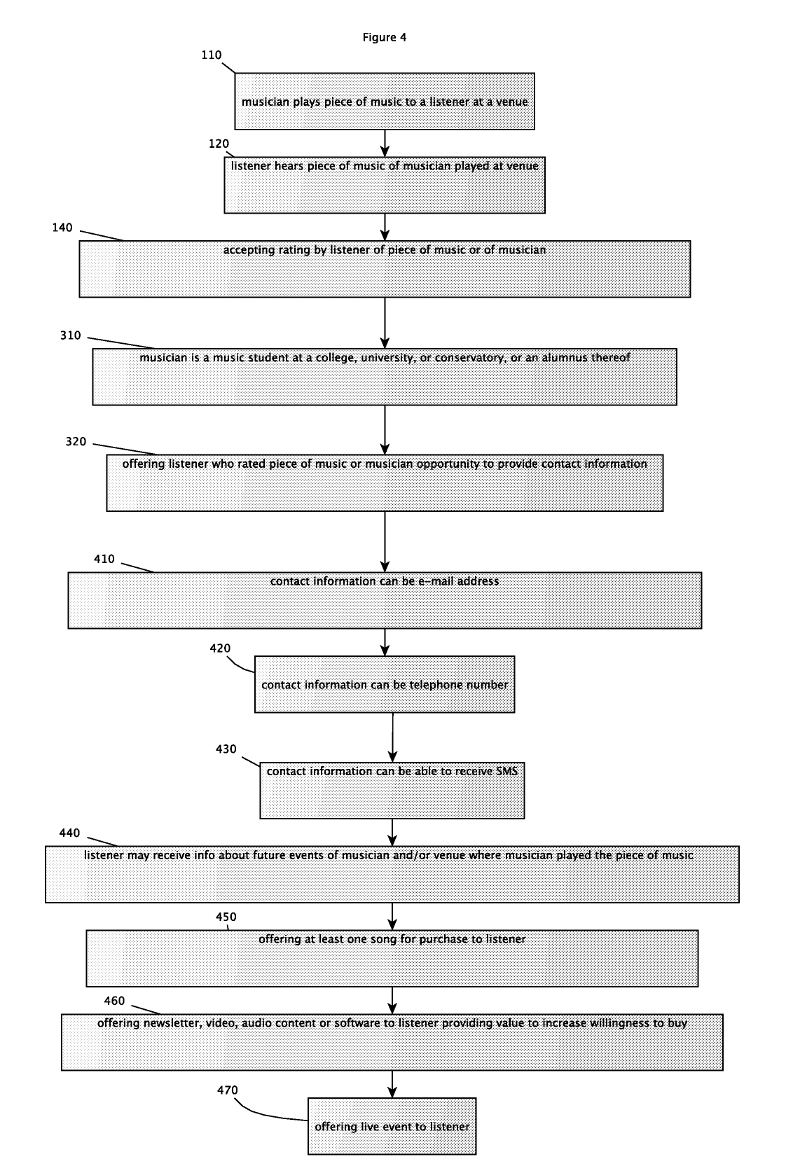

FIG. 4 is a flowchart depicting an embodiment that accepts a listener rating a musician or a piece of music, then offering the listener who rated the musician or the piece of music, the opportunity to provide contact information of the listener. Step 410, optionally, wherein the contact information of the listener comprises an e-mail address. Step 420, optionally, wherein the contact information of the listener comprises a telephone number. Step 430, optionally, wherein the contact information of the listener can accept SMS messages. Step 440, optionally, wherein the listener may receive information about future events, optionally, wherein the listener may receive information about future events of the musician, optionally, wherein the listener may receive information about future events of the venue where the musician plays or has played the piece of music to the listener who hears or has heard the piece of music of the musician. Step 450, optionally, further comprising offering at least one song of the musician for purchase to the listener. Step 460, optionally, further comprising offering video or audio or newsletter content or software-as-a-service or software-to-download to the listener that provides value to the listener, and/or increases willingness to buy of the listener. Step 470, optionally, further comprising offering at least one live event to the listener.

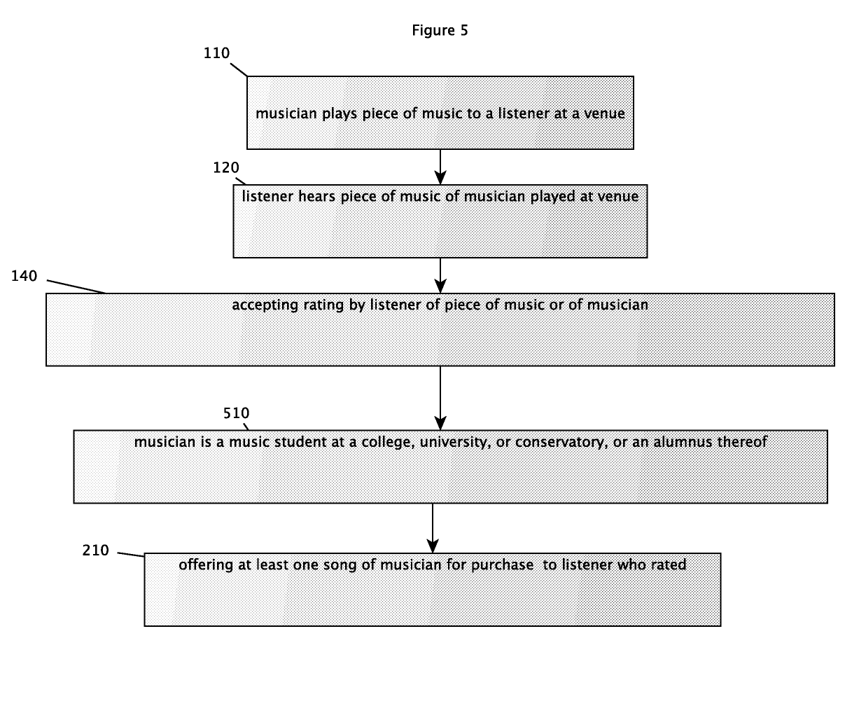

FIG. 5 is a flowchart depicting an embodiment that offers accepts a rating from a listener of a piece of music or of a musician, and offers at least one song of musician for purchase to listener who rated. Step 110, musician plays or has played a piece of music to a listener at a venue. Step 120, listener hears or has heard the piece of music of the musician. Step 140, accepting a rating by the listener of the piece of music of the musician or a rating by the listener of the musician. Step 510, wherein the musician is a music student at a college, university or conservatory, or alumnus thereof. Step 210, offering at least one song of the musician for purchase to the listener who rated the piece of music or offering at least one song of the musician for purchase to the listener who rated the musician.

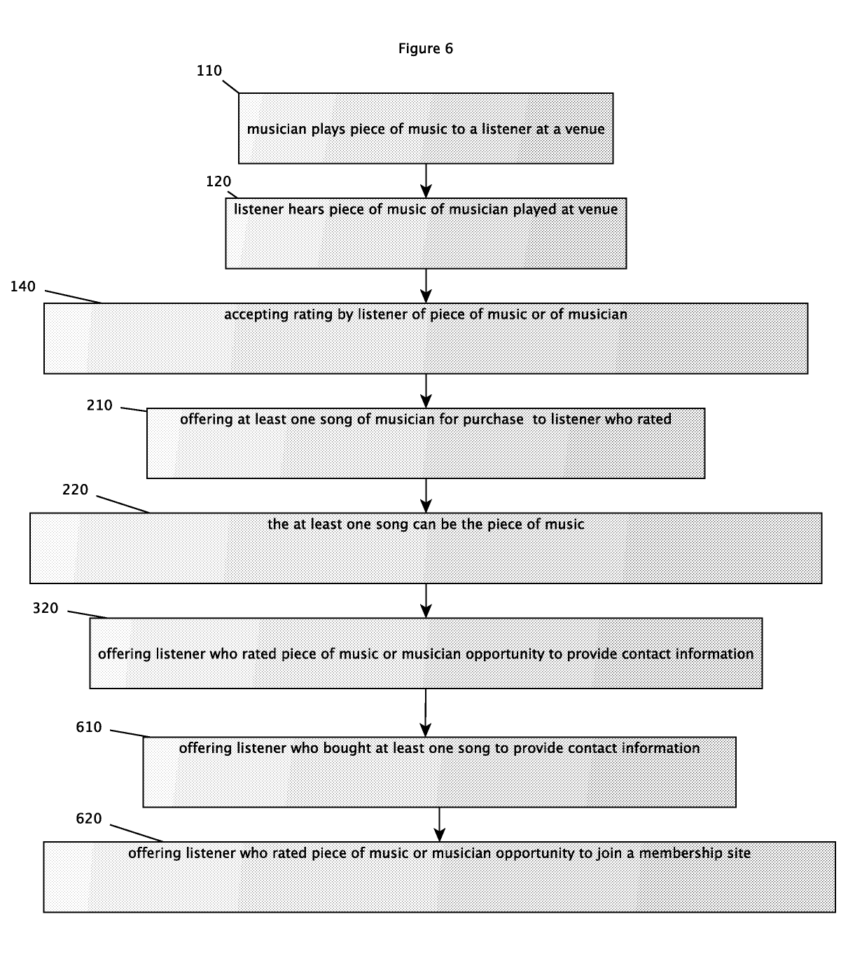

FIG. 6 is a flowchart depicting an embodiment that offers accepts a rating from a listener of a piece of music or of a musician, and offers at least one song of musician for purchase to listener who rated. Step 110, musician plays or has played a piece of music to a listener at a venue. Step 120, listener hears or has heard the piece of music of the musician. Step 140, accepting a rating by the listener of the piece of music of the musician or a rating by the listener of the musician. Step 510, wherein the musician is a music student at a college, university or conservatory, or alumnus thereof. Step 210, offering at least one song of the musician for purchase to the listener who rated the piece of music or offering at least one song of the musician for purchase to the listener who rated the musician. Step 220, wherein the at least one song of the musician comprises the piece of music. Step 320, offering the listener who rated the musician, the opportunity to provide contact information of the listener. Step 610, offering the listener who purchased at least one song of the musician, the opportunity to provide contact information of the listener. Step 620, offering the listener who rated the piece of music, or the musician, the opportunity to join an internet-based membership site.

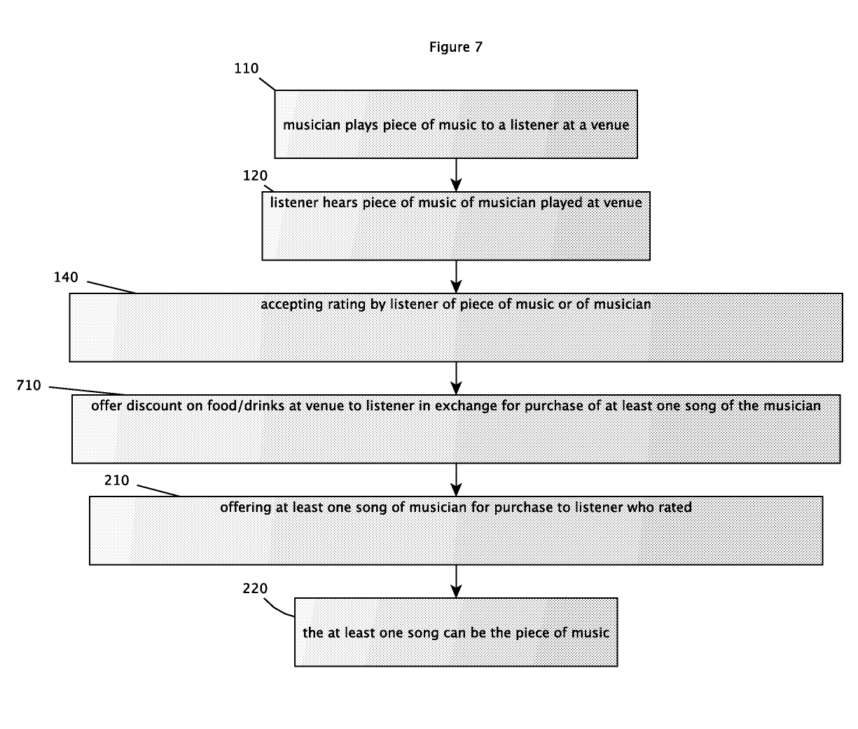

FIG. 7 is a flowchart depicting an embodiment that offers a discount on food and/or drinks at a live venue in exchange for listener purchasing at least one song of a musician whom the listener has heard and rated. Step 110, musician plays or has played a piece of music to a listener at a venue. Step 120, listener hears or has heard the piece of music of the musician. Step 140, accepting a rating by the listener of the piece of music of the musician or a rating by the listener of the musician. Step 710, offer discount on food/drinks at venue to listener in exchange for purchase of at least one song of the musician. Step 210, offering at least one song of the musician for purchase to the listener who rated the piece of music or offering at least one song of the musician for purchase to the listener who rated the musician. Step 220, wherein the at least one song of the musician comprises the piece of music.

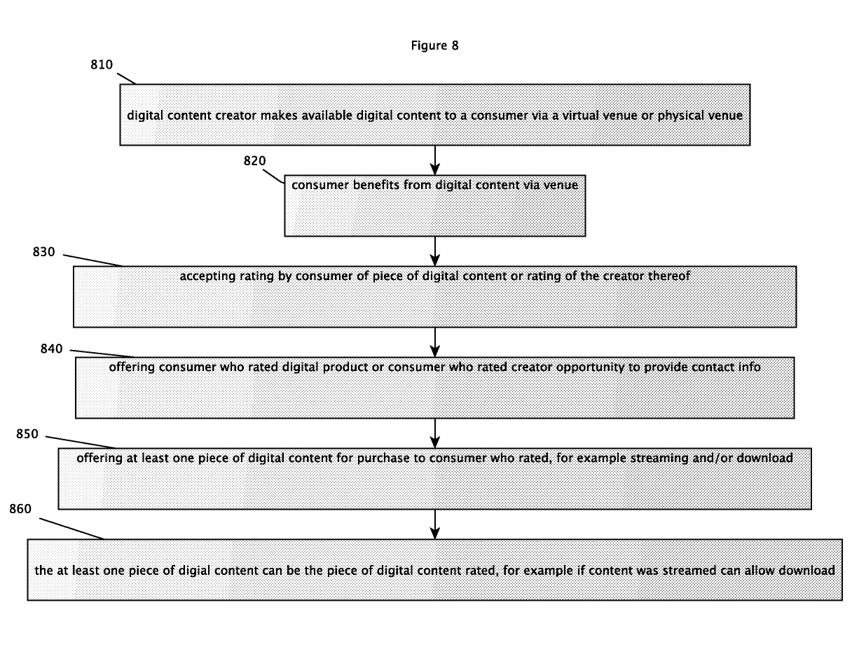

FIG. 8 is a flowchart depicting an embodiment that accepts a content consumer rating a content creator or a piece of content, then offering the content consumer who rated the content creator or the piece of content, the opportunity to provide contact information of the listener. Step 810, digital content creator makes available digital content to a consumer via a virtual venue or a physical venue, or provides non-digital content at a physical venue or via a virtual venue. Step 820, consumer benefits from digital or non-digital content. Step 830, accepting rating by consumer of a piece of digital or non-digital content or rating of the creator thereof. Step 840, offering consumer who rated digital product or consumer who rated creator opportunity to provide contact information. Step 850, offering at least one piece of digital content or non-digital content for purchase to consumer who rated the piece of content. Step 860, the at least one piece of digital content can be the piece of digital content rated. For example, but not limited to, the digital content rated can be provided via streaming, and the digital content bought can be downloaded. For example, but not limited to, the non-digital content rated can be a guest lecture in person or over the internet, and the non-digital content bought can be either a more detailed course, lecture series, or specific consulting arrangement.

The classic approach would require an opt-in of registration prior to being able to enjoy the digital content before accepting a rating thereof. An insight of this aspect of the present invention is that for highly engaging information and/or entertainment content provided, at least in part, in a live venue setting the speaker/performer/artist/musician/playwright/dancer, etc., may not control the access to the venue so as to easily require opt-in registration. However, once the audience has been exposed in the live venue to the information and/or entertainment, many of them are willing 58% to provide a rating of the information/entertainment and/or the teacher/entertainer. Those who provide a rating are arguably 90% likely to agree to be notified either of future events at the venue or by the teacher/performer. Thus, of those present in the room, typically 48% of those who enjoyed the information and/or the entertainment would join an email list for marketing purposes. This number is an extremely high number, particularly when compared to a common rate of conversion of much less than 3% to 5% for a lead that is dropped straight onto a sales letter. Affiliate marketers who perform endorsed marketing where the affiliate is well trusted report they sometimes can push conversions up to 6%. These aspects of the present invention provide a dramatic improvement over the prior art by leveraging the live engagement of the consumers and their willingness to rate and how through commitment and consistency they are more willing to join an email list for marketing purposes. Moreover, once on the email list, by using a method of building a discussion of needs, followed by a series of typically three video pieces of content, where the first one explains the problem of the prospect, the second explains why it is so important, and the third transitions into a sales offer, these combined will far exceed the conversion percentages mentioned above.

Aspects of my broader innovation include requesting review of digital content by a consumer after exposure of the consumer to the digital content. An example can include but not limited to review of a musician or or review of their music by a listener in real time at a live venue. However, based on market research, I have found contrary to common teaching that a digital content consumer such as a listener will be willing to join an opt-in list with a close to 50% probability without any additional opt-in incentive simply if first genuinely requested to provide a review. This is especially true but not limited to performing arts in live venues. Optionally, it could be for talks given at a conference. Optionally, it could be for a short teaching session. Optionally, it could apply to radio broadcasts. Optionally, it could apply to sales of digital content such as on-line teaching programs such as self-help or education. Currently widely available software such as wordpress fails to provide by default a tool that facilitates the flow from a rating or review to an opt-in, rather such tools are currently juxtaposed requiring the user to decide their next step.

FIG. 9 is a flowchart depicting an embodiment that provides a social-business networking profile (in wall format) that is different from existing social networks or business networks on-line. Rather than focusing on social interactions or generic business interactions, this website optionally will focus on helping music students, and alumni, interact around their love of music and their music career. 905 is a visual illustration of how distinctive attributes tailored for a musician or music student could potentially interact. Element 910 points out that this social network features a student's major as a defining characteristic: a privacy setting, a search term and a native group. For example, rather than emphasizing age, location, hometown, relationship status, looking for hookup etc., this website emphases characteristics that are more essential to music students and more helpful to them to network with each other as such. For example, it can impact the privacy settings as one may share certain information with others in the same major. For example, it can be a search term as students can be searched by their major, for example, voice or composition. For example, it can be a native group for networking and sharing purposes. Element 920, Instrument Played is also a defining characteristic as described above for major. Element 930, Status looking to join ensemble or not. Element 940, Looking for ensemble member. Element 950, Year in school, gender, music genre (these are three separate elements, each independently searchable: for example, went to a concert and met a woman who was a senior who plays jazz—can search for her here). Element 960, major mates—people who share the same major at the same music school (displayed where other sites might feature friends). Element 970, button to click on to invite this person to the clicker's ensemble or a separate button to click to request to join this person's ensemble. Element 980, make music visible to teachers—for example for the purpose of a class project on internet marketing.

FIG. 10 is a flowchart depicting an embodiment that provides a social-business networking advanced people search that is different from existing social networks or business networks on-line. Element 1005 is a visual illustration of how distinctive attributes tailored for a musician or music student could potentially interact. The following items are searchable, either independently or in arbitrary combination, 1010 first name, 1020 last name, 1030 major, 1040 ensemble name, 1050 playing with (typically person's name but could be any other combination of elements), 1060 school, 1070 sharing with searcher a major/course/school, 1080 whether searching for an ensemble or its members or its music technicians.

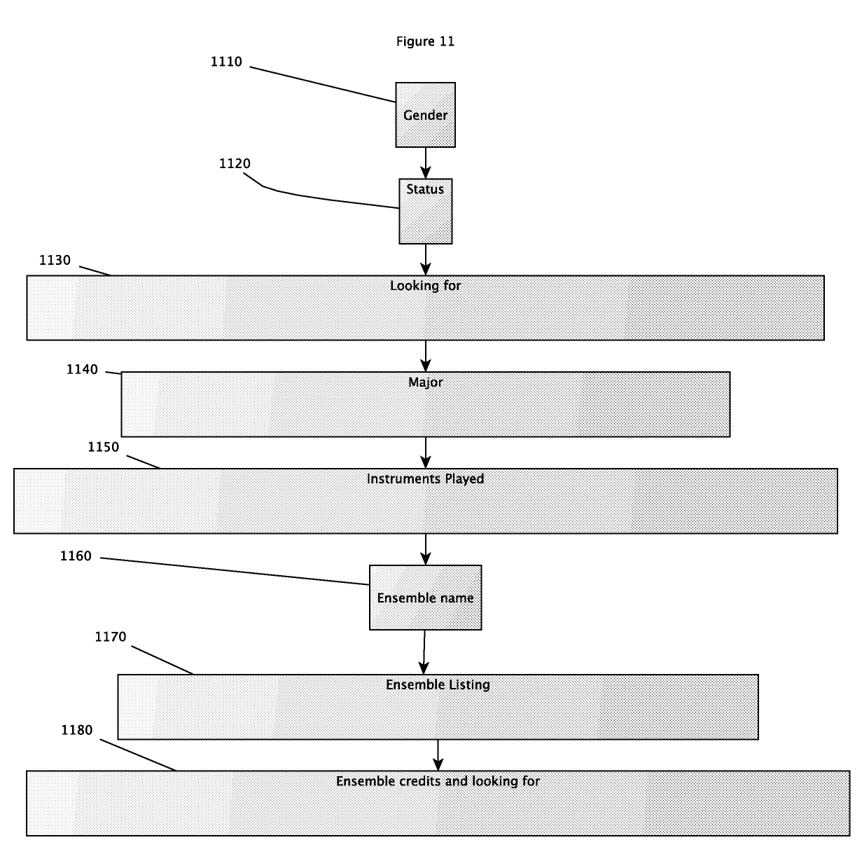

FIG. 11 is a flowchart depicting an embodiment that provides a social-business networking complementary search that is different from existing social networks or business networks on-line. Complementary search knows what the searcher is seeking based on the profile and will find other members who most closely match those criteria. In mutual complementary search mode, it will find other members who have the combination of most closely matching the criteria of the searcher and of the displayed member. Search can be performed by an individual or an ensemble and may return either, or both, as a result. Element 1105 is a visual illustration of how distinctive attributes tailored for a musician or music student could potentially interact. For example, the rockers are looking for a guitarist and a composer. So, the complementary search might return a female composer (whom is a music student named Shakira) and a male ensemble leader who plays guitar (who is a music student named Bruce). As my system evolves, it will notice that Bruce is already a member of the ensemble in the voice role, but the current illustration is simplified for illustration purposes. Musicians will implicitly search on a wide variety of elements by selecting complementary search: 1110 gender, 1120 status such as solo musician, ensemble member, or ensemble leader, etc., 1130 looking for—what type of ensemble member or collaborate is sought, 1140 major, 1150 instruments played, 1160 ensemble name, 1170 ensemble listing, 1180 ensemble credits and what types of people seeking to recruit to ensemble.

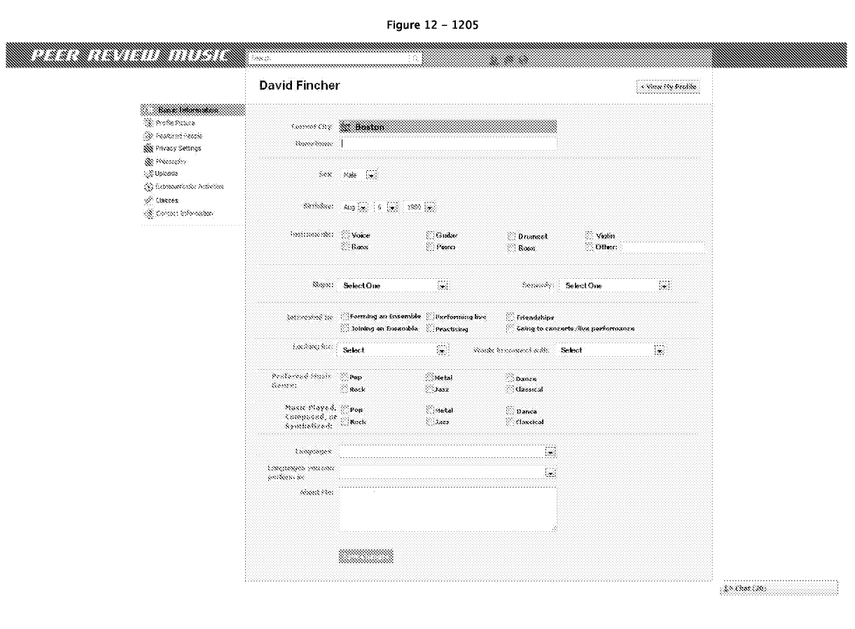

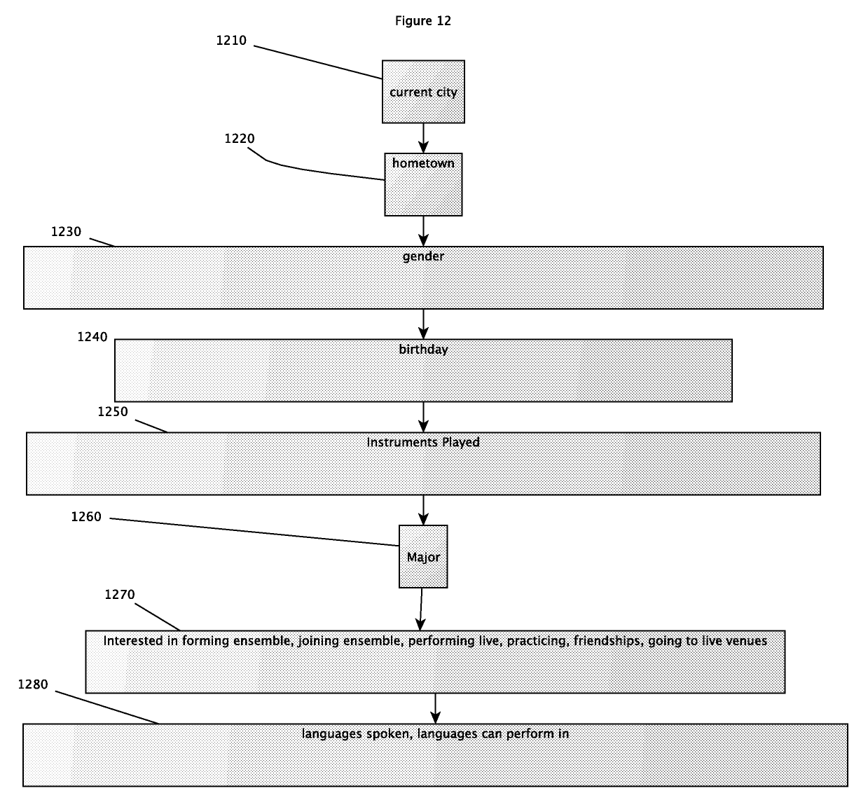

FIG. 12 is a flowchart depicting an embodiment that provides a social-business networking profile registration form that is different from existing social networks or business networks on-line. This profile registration focuses on elements useful to musicians to get to know each other and/or for fans to get to know musicians. Element 1205 is a visual illustration of how distinctive attributes tailored for a musician or music student could potentially interact. For example, 1210 current city, 1220 hometown, 1230 gender, 1240 birthday, 1250 instruments played, 1260 major, 1270 interested in forming ensemble, joining ensemble, performing live, practicing, friendships, going to live venues, and/or 1280 languages spoken and/or language can perform in.

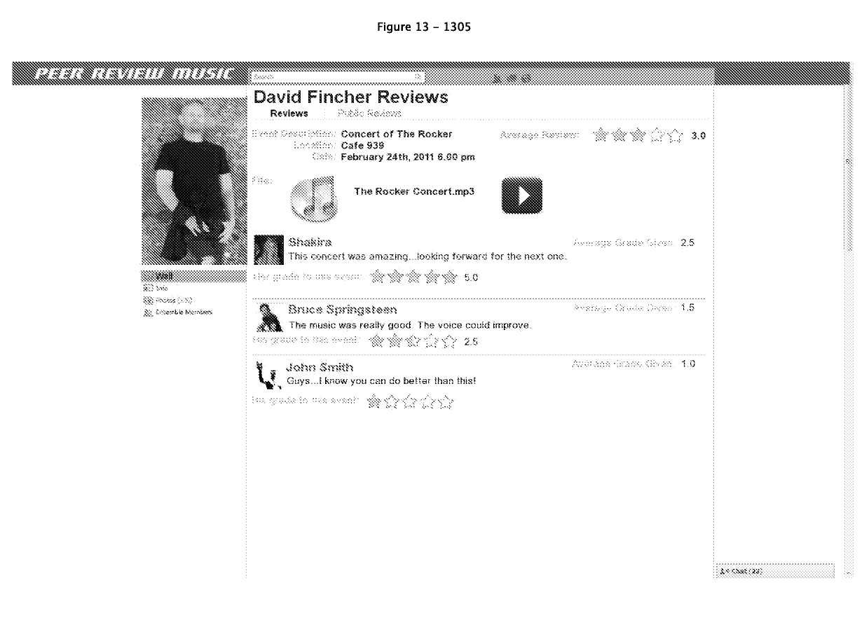

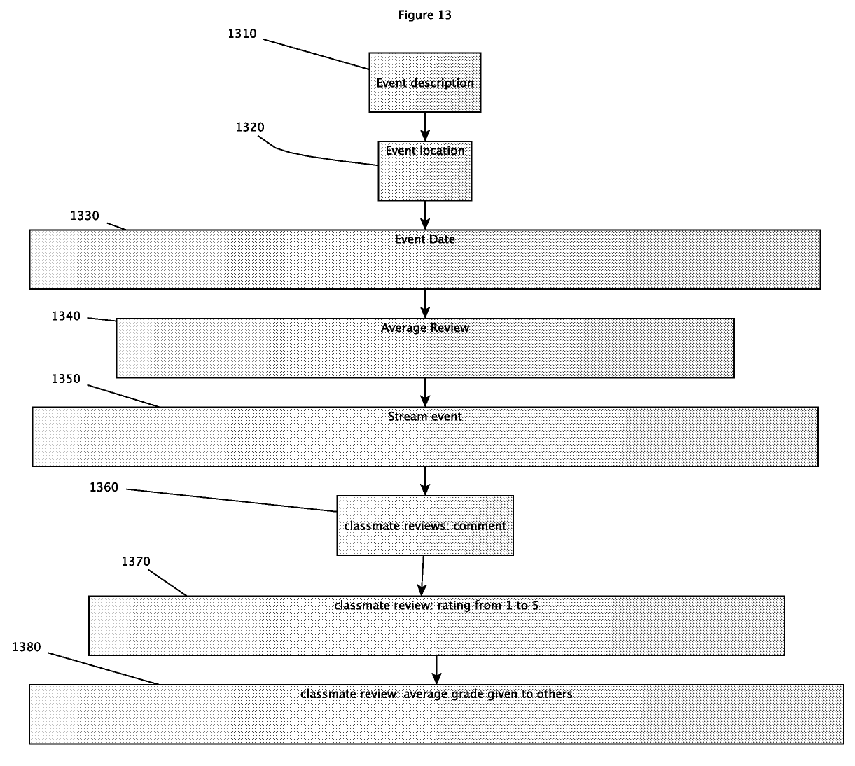

FIG. 13 is a flowchart depicting an embodiment that provides a social-business networking registered user review page that is different from existing social networks or business networks on-line. This registered user review page focuses on elements useful to musicians to get to know each other and/or for fans to get to know musicians. A registered user can post a review on this page after being present at a concert, and live event. Typically, it is by invitation but the website will allow registered users to search of a musician or an ensemble and their corresponding event. The user will select which musician and/or event to rate. Element 1305 is a visual illustration of how distinctive attributes tailored for a musician or music student could potentially interact. For example, 1310 event description, 1320 event location, 1330 event date, 1340 average review, 1350 stream event, 1360 classmate reviews comment, 1370 classmate review rating from 1 to 5, 1380 classmate review average grade given to others.

FIG. 14 is a flowchart depicting an embodiment that provides a social-business networking mobile music review application that is different from existing social networks or business networks on-line. This mobile music review application focuses on elements useful to musicians to get to know each other and/or for fans to get to know musicians. A listener can post a review on this page after being present at a concert, and live event. Typically, it is by invitation by publicizing a link. Element 1405 is a visual illustration of how distinctive attributes tailored for a musician or music student could potentially interact. For example, 1420 event description, 1430 event location, 1440 event date. In this example embodiment, the listener has three options: 1450 to sign in as an existing registered user to get credit for reviewing the artist, 1460 claim an existing review to associate new or existing username with an existing review to get credit for reviewing the artist, 1470 sign up as a new member prior to creating a review for the artist. This functionality is distinctive relative to our known market because classic internet marketing recommends requiring an opt-in (i.e. registration prior to review, and thus has no specific process for a review followed by a registration). In this application, a novel observation is made that for a live performance of a musician, people are more likely to be willing to give feedback then they are to opt-in. Moreover, their comfort level and willingness to opt-in will actually rise after they have given feedback relative to beforehand. This observation can generalize beyond musicians to other performing artists and/or guest lecturers and/or internet marketers on a virtual telesummit.

FIG. 15 is a flowchart depicting an embodiment that provides a social-business networking mobile music review application that is different from existing social networks or business networks on-line. This mobile music review application focuses on elements useful to musicians to get to know each other and/or for fans to get to know musicians. A listener can post a review on this page after being present at a concert, and live event. Typically, it is by invitation by publicizing a link. Element 1505 is a visual illustration of how distinctive attributes tailored for a musician or music student could potentially interact. For example, 1520 event description, 1530 event location, 1540 event date. In this example embodiment, the listener has two options: 1550 to review the performance with a comment and a star-based rating from 1 to 5 (could be any scale really) then to select 1560 review anonymously or to select 1570 get credit for my review. It is particularly 1570 get credit for my review that encourages the listener to review the music and then to opt-in to providing contact information.

FIG. 16 is a flowchart depicting an embodiment that provides a social-business networking anonymous user review page that is different from existing social networks or business networks on-line. This anonymous user review page focuses on elements useful to musicians to get to know each other and/or for fans to get to know musicians. An anonymous user can post a review on this page after being present at a concert, and live event. It is by invitation via a link Element 1605 is a visual illustration of how distinctive attributes tailored for a musician or music student could potentially interact. For example, 1610 event description, 1620 event location, 1630 event date, 1640 average review, 1650 stream event, 1660 anonymous review comment, 1670 anonymous review rating from 1 to 5, 1680 option to claim this review. No average ratings given to others is present here in contrast to FIG. 13, because the reviewer remains anonymous. An optional embodiment would record some user specific information that can be learned via the browser such as but not limited to IP address, OS & version, cookies, browser, and version, etc. This can be used as a proxy for a username, thus an average rating could be displayed but might not be accurate as correctly identifying one specific listener.

FIG. 17 is a flowchart depicting an embodiment that provides a social-business networking mobile music review application that is different from existing social networks or business networks on-line. This mobile music review application focuses on elements useful to musicians to get to know each other and/or for fans to get to know musicians. A listener can post a review on this page after being present at a concert, and live event. Typically, it is by invitation by publicizing a link. Element 1705 is a visual illustration of how distinctive attributes tailored for a musician or music student could potentially interact. For example, 1720 five feedback to music school students and/or receive discounts, 1730 goto favorite live venues, 1740 select event you are in, 1750 give feedback, 1760 receive discounts on music or coupons for the venue.

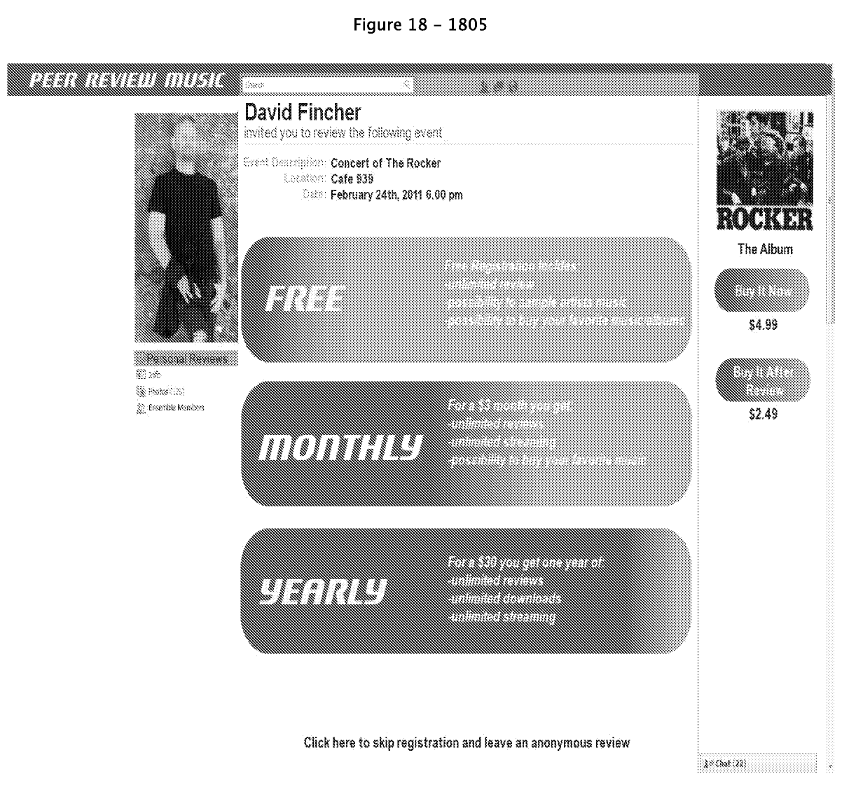

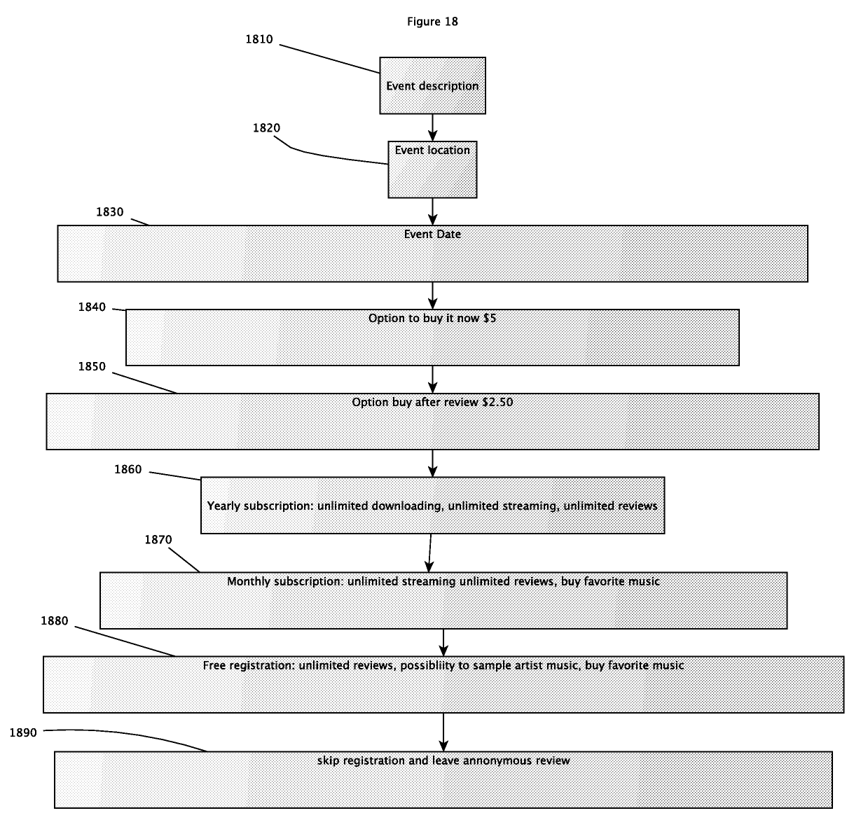

FIG. 18 is a flowchart depicting an embodiment that provides a social-business networking mobile music review registration selection, or bypass, page that is different from existing social networks or business networks on-line. This mobile music review application focuses on elements useful to musicians to get to know each other and/or for fans to get to know musicians. Element 1805 is a visual illustration of how distinctive attributes tailored for a musician or music student could potentially interact. For example, 1810 event description, 1820 event location, 1830 event date. The listener receives several options: 1840 option to buy now at full price, 1850 option to buy after review at a discounted price (actually leads the person to the review page), 1860 option for a yearly subscription which include unlimited downloads from the site, 1870 option for a monthly subscription which includes unlimited streaming from the site, 1880 free registration which includes ability to post an unlimited number of reviews, or 1890 skip registration and go directly to provide an anonymous review.

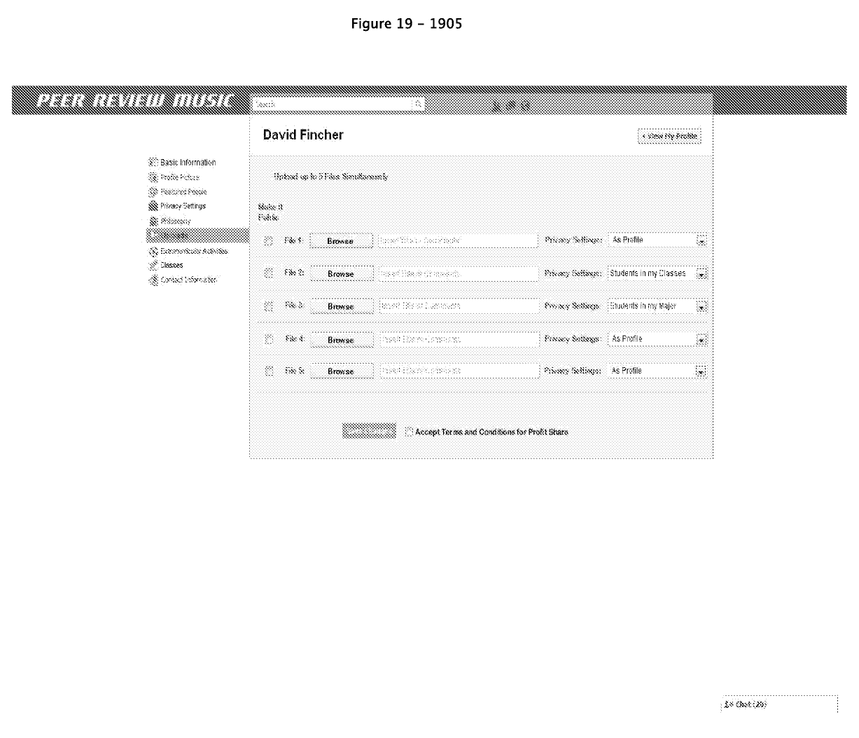

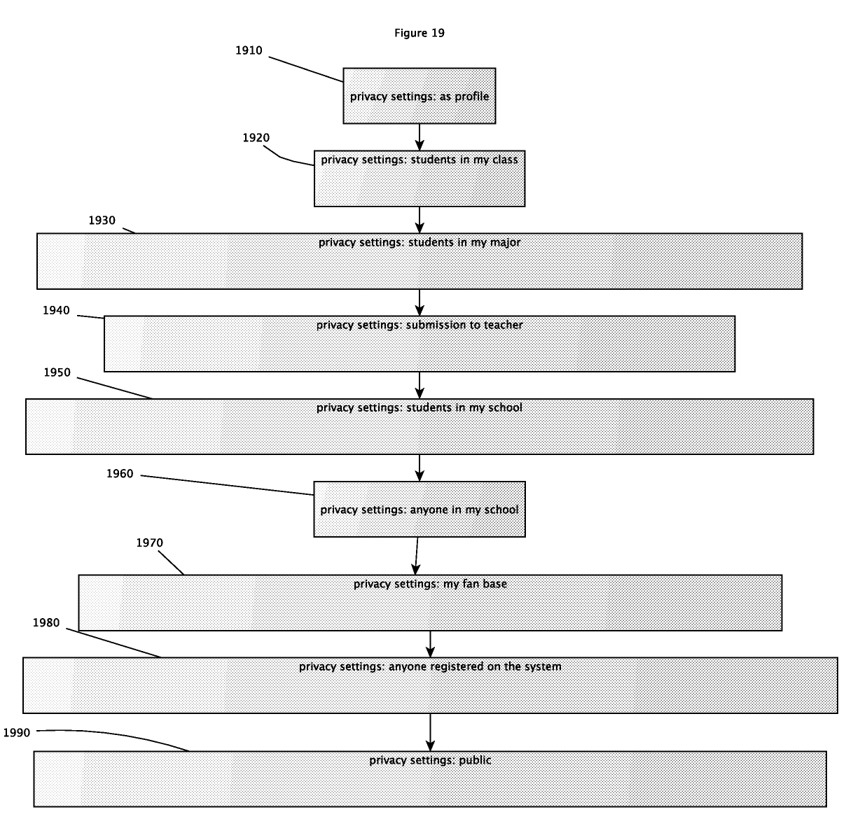

FIG. 19 is a flowchart depicting an embodiment that provides a social-business networking file upload privacy selection page that is different from existing social networks or business networks on-line. This upload privacy selection page focuses on elements useful to musicians to get to know each other and/or for fans to get to know musicians. Element 1905 is a visual illustration of how distinctive attributes tailored for a musician or music student could potentially interact. For example, 1910 privacy settings as profile, 1920 privacy settings: students in my class, 1930 privacy settings: students in my major, 1940 privacy settings: submission to my teacher, 1950 privacy settings: students in my school, 1960 privacy settings: anyone in my school, 1970 privacy settings: my fan base, 1980 privacy settings anyone registered in the system, 1990 privacy settings: public.

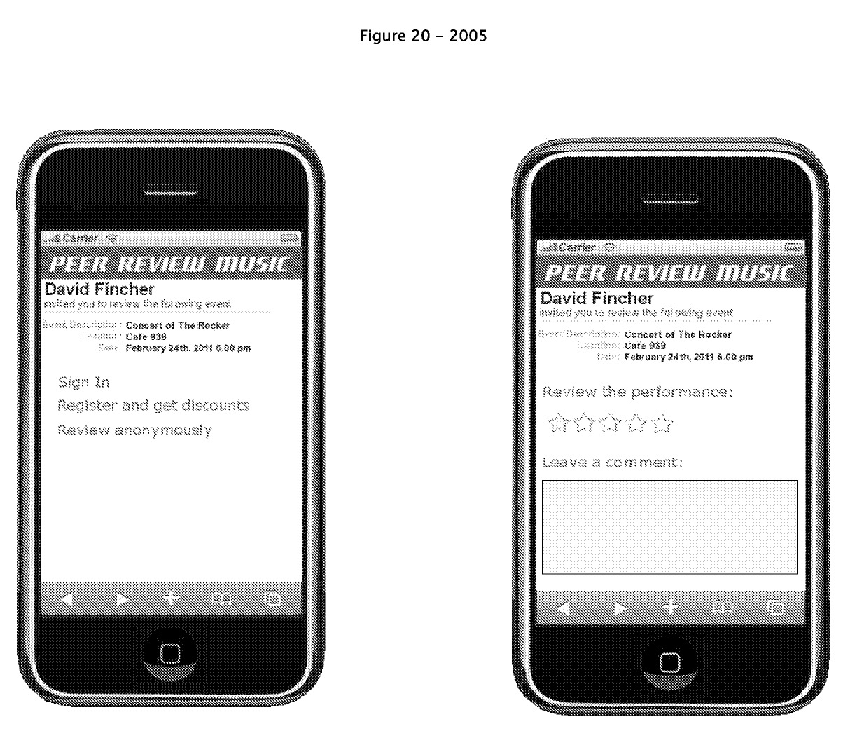

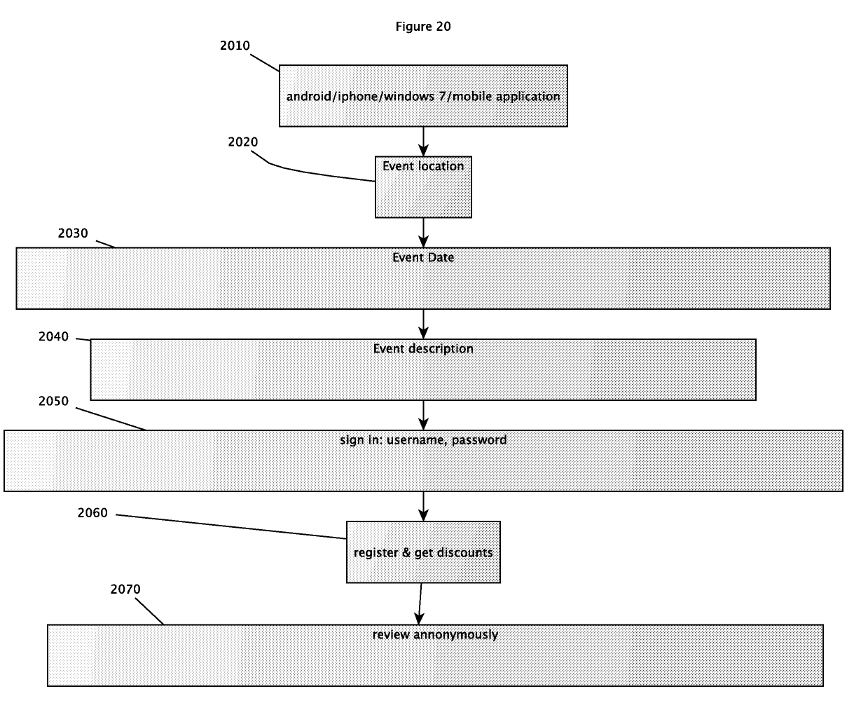

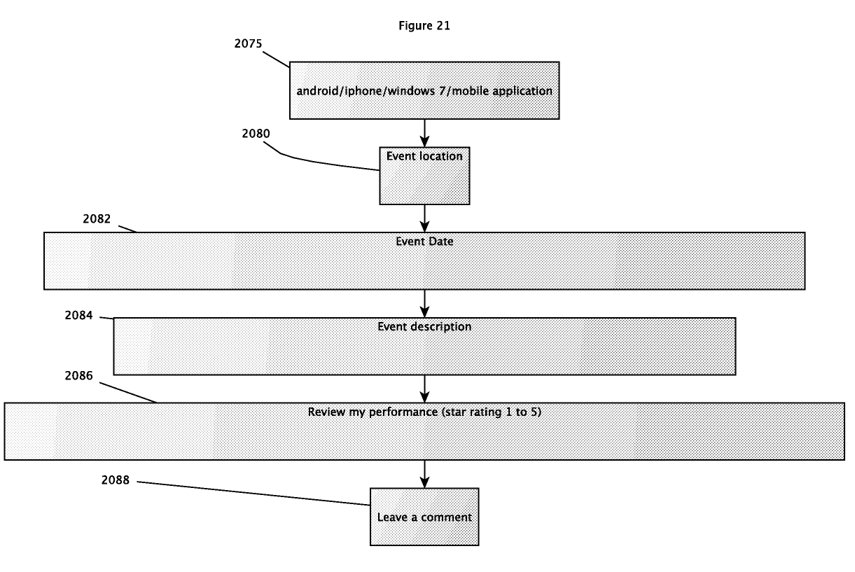

FIGS. 20 and 21 are flowcharts depicting an alternative embodiment that provides a social-business networking mobile music review application that is different from existing social networks or business networks on-line. This mobile music review application focuses on elements useful to musicians to get to know each other and/or for fans to get to know musicians. A listener can post a review on this page after being present at a concert, and live event. Typically, it is by invitation by publicizing a link. Element 2005 is a visual illustration of how distinctive attributes tailored for a musician or music student could potentially interact. For example, 2020 event description, 2030 event location, 2040 event date. In this example embodiment, the listener has three options: 2050 to sign in as an existing registered user to get credit for reviewing the artist, 2060 register and get discounts, 2070 review anonymously. This functionality is distinctive relative to our known market because classic internet marketing recommends requiring an opt-in. For example, 2084 event description, 2080 event location, 2082 event date. In this example embodiment, the listener has one option: 2086/2088 to review the performance with a comment and a star-based rating from 1 to 5 (could be any scale really).

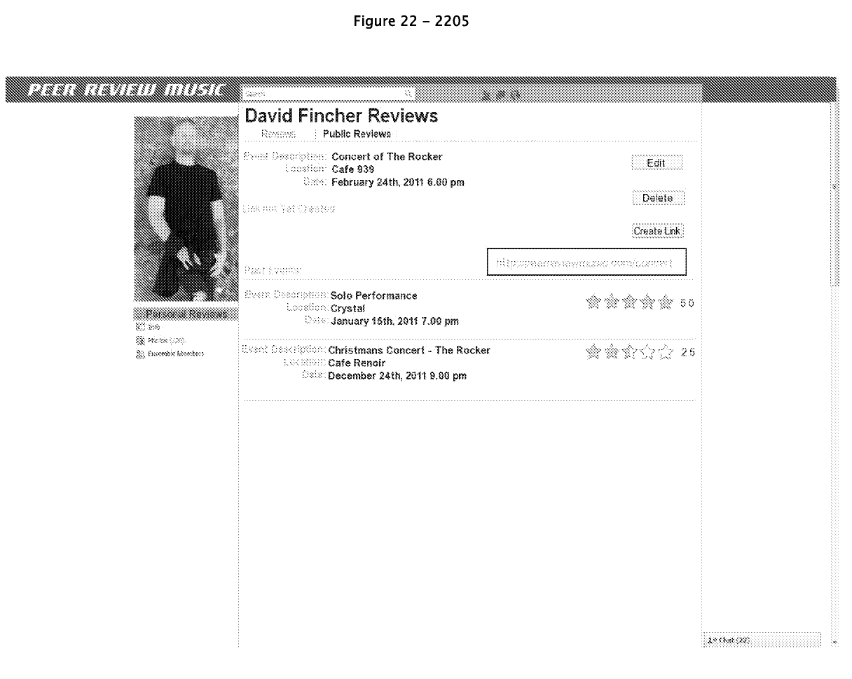

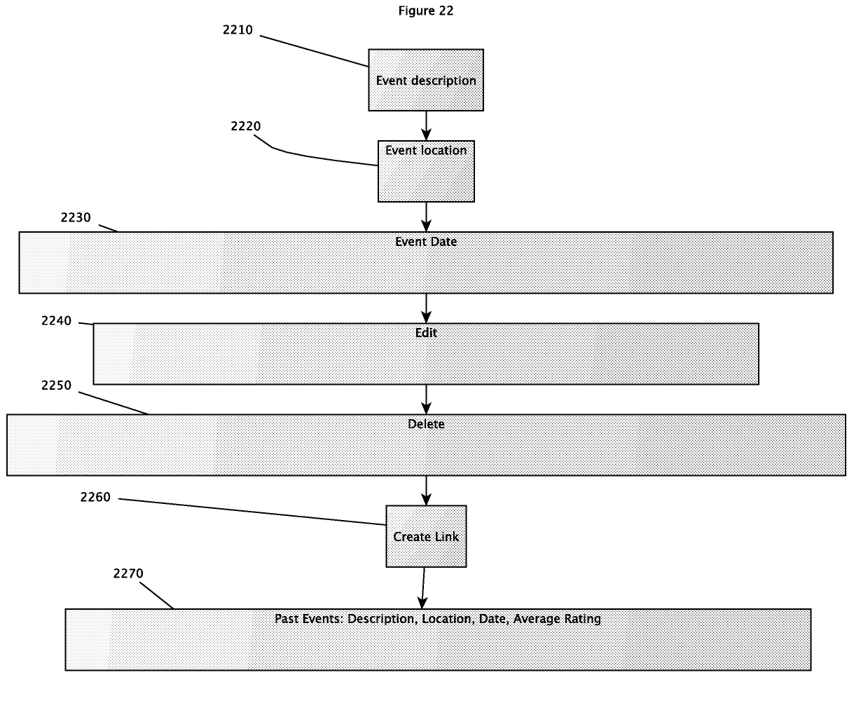

FIG. 22 is a flowchart depicting an embodiment that provides a social-business networking user review page creation screen that is different from existing social networks or business networks on-line. This user review page creation screen focuses on elements useful to musicians to get to know each other and/or for fans to get to know musicians. Element 2205 is a visual illustration of how distinctive attributes tailored for a musician or music student could potentially interact. This page allows the musician to 2260 create a link that enables listeners and fellow musicians present at 2210 event description, a live performance at 2220 event location on 2230 event date. The musician can also edit 2240 (i.e. rename) or delete 2250 an existing link. Past events 2270 with their respective ratings can be made available on the page.

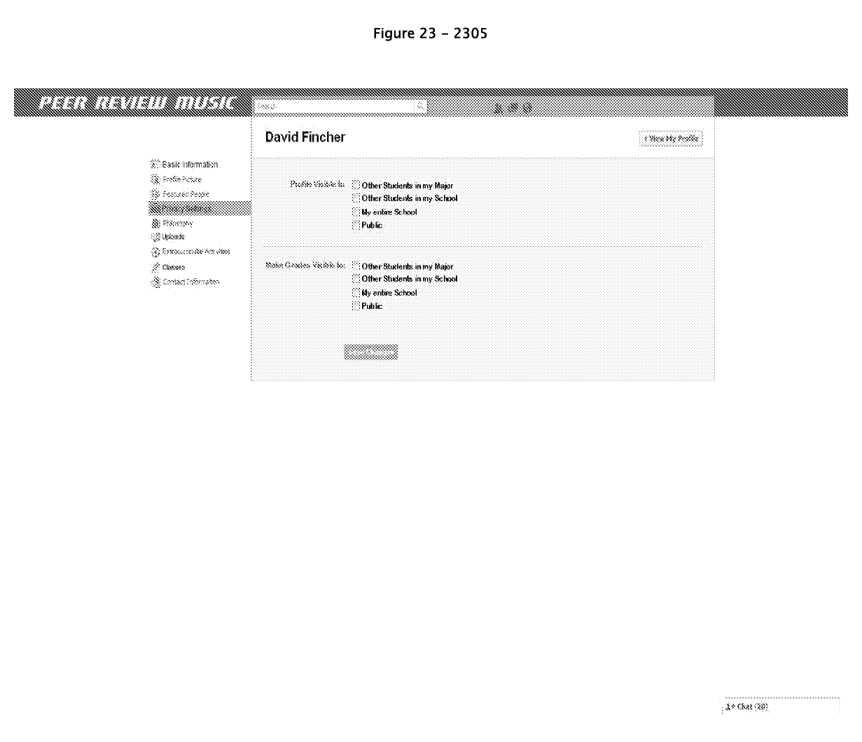

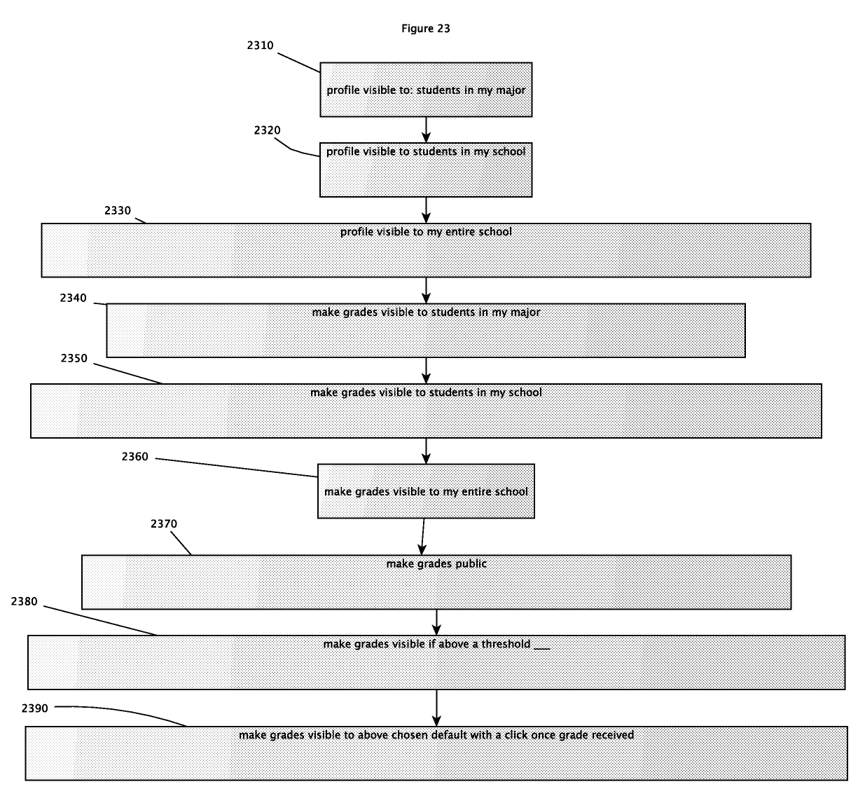

FIG. 23 is a flowchart depicting an embodiment that provides a social-business networking profile privacy and grades privacy settings page that is different from existing social networks or business networks on-line. This profile privacy and grades privacy settings page focuses on elements useful to musicians to get to know each other and/or for fans to get to know musicians. Element 2305 is a visual illustration of how distinctive attributes tailored for a musician or music student could potentially interact. Element 2310 profile visible to students in my major, 2320 profile visible to students in my school, 2330 profile visible to my entire school, 2340 make grades visible to students in my major 2350 make grades visible to students my school, 2360 make grades visible to my entire school, 2370 make grades public, 2380 make grades visible if above threshold ______, 2390 make grades visible to above chosen default with a click once grade received.

Optional aspects of the present invention is designing and implementing an innovative system to advance music schools, musicians, and the music industry. Optional aspects of the present invention will be a web-based aggregation of music-student-centric music, music-student-centric community interactions with a focus on creation and performance of music. Categorizing and qualifying this music I create a pool of accessible music for listeners who initially will be classmates, then teachers, then friends, alumni, and potential recruits to that school.

Through this music and these music creation focused interactions optional aspects of the present invention will provide an incentive for alumni to renew affiliation with their alma mater. Creating a vibrant alumni-network, including friends and family of the musicians, together with a showcase for student musicians enables an opportunity to support the study of that musician, a performance, a class, a major, or even a department within a music school.

### Optional Aspects of Invention: Primary Compatibility Issues

Browser compatibility resizing: iPhone, Android, Firefox, Safari, Explorer
   Must support browsers and hardware less than two years old
   Threshold is 1%-5% market penetration to determine support
Internationalization focus on US, Europe and Japan (version 2.0)
Blind and disabled users (not a core segment of our university going population, will re-evaluate this position as resources permit)

### Optional Aspects of Invention: Listeners

Listeners show an affiliation to an academic institution by providing an email address with an “edu” extension, and verifying ownership of that email address via a confirmation email.
Listeners specify their major, status within the academic community such as student/faculty/staff/alum
Listener defaults to community radio mode (unless listener is a musician)
Listeners can adjust indications of whether they are listening due to course-work, tolerance for new songs prior to other listeners perhaps classifying themselves along the adoption curve, preference for their home community as against other communities, preference for a name brand community.
Listener can adjust from community radio mode (where music is selected based on listening preferences of musicians within a community) to local community mode (where music is selected based on that individual's listening preferences)
Listener can specify their mood or activity from a limited list and can submit suggestions for new categories of mood
Listener views current song playing with information in a panel
Listener can select the next song to play, primarily from a list
Listener can learn more about recommenders by selecting one
System learns automatically by listener song selection and timing

### Optional Aspects of Invention: Musicians

Defaults to local community mode, can adjust to community radio mode
Posting music requires placing it after someone else's music
Placing after (“opening for”) is competitive among followers
Status in community: student/teacher/alum/staff/recruit/donor
Relationships: classmates, students of/teacher of, friends, co-performers (ranking the importance of performance such as recital-low to live-paid-concert-high)
Acceptance by musician who placed after helps ranking, as does a pre-existing relationship such as classmate or schoolmate.
Focus initially on students building careers, meeting each other
Enables musicians to showcase music where it will be found
Support for music you are connected to, for example, to focus on music of relatives or personal friends, enables donations
Musicians show an affiliation to an academic institution by providing an email address with an “edu” extension, and verifying ownership of that email address via a confirmation email.
Musicians specify their major, status within the academic community such as student/faculty/staff/alum
Musicians select from a menu of licensing options
   optional, default: Scholarship fund drawing on revenue share pool of 20% of our revenues from individual subscriptions, and revenue from third-party advertisers, in exchange for to be determined rights to stream any music posted of theirs on optional aspects of the present invention
   optional, bystander: right to stream music of theirs posted on optional aspects of the present invention forever, gain credits to enable preferred placement
   optional, sweetheart: agreement to sign us as the 360-record label once their music reaches our then determined threshold, in exchange for preferred placement early on, and a cash bonus later
Optional, any of the long-term rights buyable by the musician for a standard price comparable to that when a manager or independent label conveys its rights to a major record label.

### Optional Aspects of Invention: Music Communities

Administrators accept, reject, or revoke affiliation of musicians/listeners
Administrators preload list of affiliated musicians, and listeners, together with their user-names and a way to authenticate them
Administrators preload achieve music
Administrators specify classes that particular students take
Integrated system with on-line course materials website
Integrate system with admissions office

### Optional Aspects of Invention: Disk Jockeys

Ability to upload music to optional aspects of the present invention
Login based on station email address, use it for confirmation
Music played to a limited geographic region
Radio station pays a per-play fee or for a specific report

### Optional Aspects of Invention: Radio Stations

Verified by station email domain
Administrators for their Disk Jockeys, can add, remove, confirm
Accept obligation for payment of per-play fee and receives reports

### Optional Aspects of Invention: Record Labels

Verified by label email domain
Administrators for their signed musicians, can add, unsign, confirm
Accept obligation for payment of per-play fee and receives reports
Agrees to legal obligations relative to signed musician and gets paid

### Optional Aspects of Invention: In House

Graphical display and explanation of
   Local listener table (LLT) transitions per listener for each song
   Local trusted recommender (LTRT) table with reputations per listener, based on acceptance by listener of recommender model
   Song-based graph displaying what songs it is best to follow
   Showing how songs interrelate based on transition chances
   Showing a listener traversing LLT or LTRT, and modifying it
   How song acceptance increases over time
   How songs when placed migrate position and find a spot

### Optional Aspects of Invention: Local Community Mode

Logo: G-Clef with graduation hat
Title: optional aspects of the present invention at Community Name
Local Community Mode
Scrolling Pane on selected song
   Cover art, title, artist, album, label, relationship to listener
   Video stream
   Lyrics
   Program notes
   Sheet music
   Upcoming events: class, musician, community
Playing next mode
   Radio button choose among four suggested songs
      display cover art miniature (see Henri mockup) with title
   Request a new set of suggested songs
   Information request on a song changes scrolling panel
   Ability to play next (green), or play now (red)
Listener in Community
   Home community
   Status within the community
   Picture
   email address at domain
   Openness to new music (scale)
   Openness to other communities (scale)
   Specify mood, Specify location (guess based on IP), Specify Gender/age/geographic region i.e. zip code/language
Music Player
   Play/Pause, Skip Play Less
   Volume scale/mute
   Categorize by mood, Bookmark Play More
Alternative suggestions for songs
   Panel of songs by that musician
   History of songs heard
Display transitions
   Show a graphic representation on scale 0-100 of transition
      current song to next song
      connections between previous songs
   As system adjusts displays changed connection
   Separate screen showing
      Acceptance rate growing over time
      Growth of listeners, listener hours, music uploaded
      Breakdown of listener demographic by song
         Optional Aspects of Invention: Community Radio Mode—Inherit Specification from Above
Community Radio Mode
Playing next mode
   Radio button choose among four suggested songs
      each song displayed with system supplied recommender
      display cover art miniature (see Henri mockup) with title
   Request a new set of suggested songs
   Information request on a song changes scrolling panel
   Ability to play next (green), or play now (red)
   Information request on recommender changes scrolling panel
Alternative suggestions for songs
   Panel of songs by musician, recommended next songs for each
   History of songs heard with recommender selected by system
Display transitions
   Show a graphic representation on scale 0-100 of transition
      current song to next song
      connections between previous songs
   As system adjusts displays changed connection
   Show graphically reputation of recommenders in listener eyes
   Dynamically update graphical reputation of recommenders
   Separate screen showing
      Acceptance rate growing over time
      Growth of listeners, listener hours, music uploaded
      Breakdown of listener demographic by song

### Optional Aspects of Invention: Social Networking Aspect

Display of classmates, friends, co-performers, teachers, major/instrument
Display of recent recommenders, who trusts me
Add a class
Ability to add a classmate, friend, co-performer, teacher
Ability to add a class, performance; to join an existing class
School administrator may add users, classes, and teachers, or students
Class may require teacher confirmation, or student confirmation
Friendship requires confirmation, unconfirmed friend is a fan
Musicians may request to be a protégé, requires confirmation
Performance may require confirmation by other group members
Teacher or admin can post materials for students of class
Add a recital, request accompaniment, request a room, get a room
Different colors depending on whether information is self-stated, confirmed, or certified by an authorizing body (e.g. a university)
Listener in Community
   Home community
   Status within the community
   Picture
   email address at domain
   Openness to new music (scale)
   Openness to other communities (scale)
   Specify mood, Specify location (guess based on IP), Specify Gender/age/geographic region i.e. zip code/language

### Optional Aspects of Invention: Social Networking Mockup (Features)

Recommendations that appear on profile with status of recommender
Venues can specify how many came to a concert (to appear on profile)
   Under Appreciated Trends that I have Identified

a. The huge problem for music school students is to be able to sell their music while they are still in school

b. Many of them perform music at local venues in front of live audiences

c. Many people who attend the venue do so for the music,

d. Many people would rate the music of a performance,

e. Many people who rate music would purchase the music at a discount, and even more so if get discount on drinks at venue.

Aspects of embodiments of invention may form missing link between willingness and desire of fans to purchase music student music and actual cash-in-bank plus customer-list-in-computer. Thus, a music student can complete their studies with say a list of 1,000 customers who actually purchased their music. That is a tremendous asset both for convincing others of the viability of their music career, and their ability to connect with their audience and create further music they would crave.

Having an internal peer musician website enables an interaction with another musician after the other musician has head their music. It allows for a more efficient process of forming performing groups.

It will be appreciated that aspects of the invention apply more broadly then musicians selling pre-recorded music based on a performance in a live venue. Typically on-line a consumer is required to register in order to be able to provide feedback, or can provide feedback without registering, but not allowing the anonymous feedback then accepting a registration as next step. For example, a sales site sends a consumer directly to a registration or purchase page (with optional registration before purchase). Not even groupon offers coupons before registering. iTunes one cannot purchase without registering.

Previously, many people would not wait in line to speak with a musician or to purchase a CD after a concert or live venue performance. Relationships are extremely critical, so aspects of the invention provide tremendous value.

The listener can rate either the piece of music that they heard at the venue, or they can rate the musician's performance.

The radio stations ensured their short-term profit margins grew by eliminating the taste-setting risk-taking human-capital intensive expert disk jockeys, while destroying the both the vitality of the listener experience and the core ecosystem that made both radio stations and music labels able to innovate and bring new music to the public. Optionally, a novel software system to enable music students to sell their music without requiring a record label and while those music students are still studying in school. Optionally, built upon deep insight into the music industry, how music venues operate, and an understanding of consumer psychology.

Yet, music students today spend more money each year getting an education in music in this country then all of the musicians of the world accumulate in gross revenues from selling recorded music in this country.

### CONCLUSION

Described above are systems and methods achieving the objects set forth above, among others. It will be appreciated that the embodiments shown in the drawings and described herein are merely examples of the invention, and that other embodiments incorporating changes thereto fall within the scope of the invention.

In view of the foregoing, what I claim is:

1. A method for building a customer base for a musician, comprising
A. offering a discount on food or drinks at a venue where a musician plays or has played a piece of music to a listener who hears or has heard the piece of music of the musician, the offering is to be in exchange for the listener providing a rating of the piece of music of the musician or the listener providing a rating of the musician,
B. accepting a rating by the listener of the piece of music of the musician or a rating by the listener of the musician.

2. The method of claim 1, further comprising offering at least one song of the musician for purchase to the listener who rated the piece of music or offering at least one song of the musician for purchase to the listener who rated the musician.

3. The method of claim 2, wherein the at least one song of the musician comprises the piece of music.

4. A method for building a customer base for a musician, comprising
A. accepting a rating by a listener who hears or has heard a piece of music of a musician or a rating by the listener of the musician,
B. offering the listener who rated the piece of music, or offering the listener who rated the musician, the opportunity to provide contact information of the listener.

5. The method of claim 4, wherein the contact information of the listener comprises an email address.

6. The method of claim 4, wherein the contact information of the listener comprises a telephone number.

7. The method of claim 4, wherein the contact information of the listener can accept SMS messages.

8. The method of claim 4, wherein the listener may receive information about future events.

9. The method of claim 4, wherein the listener may receive information about future events of the musician.

10. The method of claim 4, wherein the listener may receive information about future events of the venue where the musician plays or has played the piece of music to the listener who hears or has heard the piece of music of the musician.

11. The method of claim 4, wherein the musician can provide a newsletter to the listener.

12. The method of claim 4, further comprising offering at least one song of the musician for purchase to the listener.

13. The method of claim 4, further comprising offering video or audio or newsletter content or software-as-a-service or software-to-download to the listener that provides value to the listener, and/or increases willingness to buy of the listener.

14. A method for building a customer base for a musician, comprising:
A. accepting a rating by a listener who hears or has heard a piece of music of a musician or a rating by the listener of the musician, wherein the musician is a music student at a college, university or conservatory, or alumus thereof,
B. offering at least one song of the musician for purchase to the listener who rated the piece of music or offering at least one song of the musician for purchase to the listener who rated the musician.

15. The method of claim 14, wherein the at least one song of the musician comprises the piece of music.

16. The method of claim 14, further comprising offering the listener who rated the piece of music, or the listener who rated the musician, the opportunity to provide contact information of the listener.

17. The method of claim 14, further comprising offering the listener who purchased at least one song of the musician, the opportunity to provide contact information of the listener.

18. The method of claim 14, further comprising offering the listener who rated the piece of music, or the musician, the opportunity to join an internet-based membership site.

19. A method for building a customer base for a musician, comprising
A. accepting a rating of a piece of music of a musician by a listener who hears or has heard the piece of music of the musician at a venue where the musician plays or has played the piece of music, or a rating by the listener of the musician,
B. offering a discount on food or drinks at the venue in exchange for the listener purchasing at least one song of the musician,
C. offering at least one song of the musician for purchase to the listener who rated the piece of music or offering at least one song of the musician for purchase to the listener who rated the musician.

20. The method of claim 19, wherein the at least one song of the musician comprises the piece of music.
